(19) United States
(12) Patent Application Publication
(10) Pub. No.: US 2015/0147538 A1
(43) Pub. Date: May 28, 2015

(54) CHEMICALLY STRENGTHENED GLASS PLATE, COVER GLASS, CHEMICALLY STRENGTHENED GLASS WITH TOUCH SENSOR, AND DISPLAY DEVICE

(71) Applicant: Asahi Glass Company, Limited, Chiyoda-ku (JP)

(72) Inventors: Masayuki ISHIMARU, Tokyo (JP); Hiroyuki OKAWA, Tokyo (JP); Syusaku AKIBA, Tokyo (JP); Shigeki SAWAMURA, Tokyo (JP); Kazutaka ONO, Tokyo (JP); Tetsuya NAKASHIMA, Tokyo (JP); Izuru KASHIMA, Tokyo (JP); Yusuke KOBAYASHI, Tokyo (JP); Suguru MURAYAMA, Tokyo (JP); Aya YAMAMOTO, Tokyo (JP)

(73) Assignee: Asahi Glass Company, Limited, Chiyoda-ku (JP)

(21) Appl. No.: 14/552,998

(22) Filed: Nov. 25, 2014

Related U.S. Application Data
(63) Continuation of application No. PCT/JP2013/064130, filed on May 21, 2013.

(30) Foreign Application Priority Data
May 25, 2012 (JP) 2012-119719
May 30, 2012 (JP) 2012-123353
Oct. 23, 2012 (JP) 2012-233702

(51) Int. Cl. C03C 21/00; C03C 4/18; C03C 3/085

(52) U.S. Cl. CPC C03C 21/002; C03C 3/085; C03C 4/18; C03C 2204/00
USPC 428/192

(57) ABSTRACT

A chemically strengthened glass sheet, which has front and back main surfaces and an edge surface between the front and back main surfaces, has undergone a chemical strengthening treatment and has an approximately rectangular shape, in which the chemically strengthened glass sheet has a surface compressive stress of 800 MPa or more, and an internal tensile stress of 42 MPa or less.

### TECHNICAL FIELD

The present invention relates to a chemically strengthened glass sheet favorable for cover glasses of display devices such as mobile devices such as mobile phones, personal digital assistances (PDAs), tablet PCs, etc.; touch panels; large-size thin-screen TVs such as large-size liquid-crystal TVs, etc.; and in-car meter display devices, etc.

### BACKGROUND ART

Recently, in order to improve the protection, appearance and the like of displays, cover glass (protective glass) has been frequently used for display devices such as mobile devices such as mobile phones, PDAs, tablet PCs, etc., touch panels, and liquid-crystal TVs, etc. In addition, cover glasses and the like for thin-screen TVs such as liquid-crystal TVs may be often surface-treated, for example, by forming thereon a film having a function of antireflection, impact damage prevention, electromagnetic ray shielding, near infrared ray shielding, color compensation or the like.

Such display devices are required to be lighter and thinner for reducing the load for differentiation in thinned designs and for movement. Consequently, it is also required to thin the cover glasses for use for display protection. However, when the cover glasses are thinned, then the strength thereof lowers, and the cover glasses themselves in stationary devices would be broken owing to the impact by flying or dropping objects and those in mobile devices would be broken owing to dropping in use of the devices, and such thinned cover glasses have a problem in that they could not fulfill the primary role thereof to protect display devices.

For solving the above-mentioned problem, it may be taken into consideration to increase the strength of the cover glasses, for which, generally known is a method of forming a compressive stress layer on the surface of glass.

As the method of forming a compressive stress layer on the surface of glass, there are typically mentioned an air-cooling strengthening method of rapidly cooling the surface of a glass sheet that has been heated up to around the softening point thereof, by air-cooling or the like (physically strengthening method), and a chemically strengthening method of exchanging the alkali metal ion having a small ionic radius (typically Li ion, Na ion) in the surface of the glass sheet with an alkali ion having a larger ionic radius (typically K ion) through ion-exchanging at a temperature not higher than the glass transition point.

As described above, cover glasses are required to be thin. However, when an air-cooling strengthening method is applied to a thin glass sheet having a thickness of less than 2 mm that is required for cover glasses, then it is difficult to form a compressive stress layer since a temperature difference hardly occurs between the surface and the inside of the sheet, and therefore the intended high-strength characteristics could not be realized. Consequently, generally used are cover glasses strengthened according to a chemically strengthening method.

As the cover glasses of the type, widely used are those produced by chemically strengthening soda-lime glass (for example, see Patent Document 1).

Soda-lime glass is inexpensive, and has a characteristic feature in that the surface compressive stress S of the compressive stress layer formed on the glass surface through chemical strengthening could be 550 MPa or more, but has a problem in that it is not easy to make the compressive stress layer have a thickness DOL (hereinafter this may be referred to as depth of compressive stress layer) of 20 μm or more. Glass in Example 28 to be given hereinunder is soda-lime glass.

Given the situation, one produced by chemically strengthening SiO₂—Al₂O₃—Na₂O-based glass that differs from soda-lime glass has been proposed for cover glasses (for example, see Patent Documents 2 and 3).

The SiO₂—Al₂O₃—Na₂O-based glass can have not only the above-mentioned value S of 550 MPa or more but also, as another characteristic feature thereof, the above-mentioned value DOL of 20 μm or more.

Heretofore known are display devices having a touch panel function (for example, mobile phones, personal digital assistances (PDAs), tablet PCs, etc.). The display device of the type is so configured that a glass substrate with a touch sensor mounted thereon is arranged on a liquid-crystal display (LCD) and a chemically strengthened glass is further mounted thereon as a cover glass (FIG. 33A).

Recently, as in Patent Document 4, for lighter and thinner ones, so-called 2-in-1 type display devices have been developed, in which a touch sensor is directly mounted on chemically strengthened glass to omit a glass substrate and the chemically strengthened glass with the touch sensor mounted thereon is arranged on a liquid-crystal display (LCD) (FIG. 33B).

As the chemically strengthened glass with a touch sensor for use in such 2-in-1 type display devices, three types of chemically strengthened glass are now distributed. The first is chemically strengthened glass of which the surface compressive stress S of the compressive stress layer is 500 MPa and the depth of the compressive stress layer DOL is 9 μm; the second is chemically strengthened glass of which the surface compressive stress S of the compressive stress layer is 722 MPa and the depth of the compressive stress layer DOL is 32 μm; and the third is chemically strengthened glass of which the surface compressive stress S of the compressive stress layer is 623 MPa and the depth of the compressive stress layer DOL is 19 μm.

### BACKGROUND ART DOCUMENT

### Patent Document

Patent Document 1: JP-A-2007-11210

Patent Document 2: US 2009/0298669

Patent Document 3: US 2008/0286548

Patent Document 4: JP-A-2011-197708

### SUMMARY OF THE INVENTION

### Problems that the Invention is to Solve

Mobile devices are often dropped from hands, pockets or bags and the cover glasses thereof are often scratched (to have indentations), or as the case may be, dropped mobile devices would be stamped, or mobile devices, while kept in pockets, would be sat on, or that is, cover glasses would be frequently given a great load applied thereto.

The surface compressive stress S of cover glasses heretofore used in the art is from 650 to 750 MPa, however, in consideration of the possibility that a larger load as above would be given thereto, cover glasses having a larger surface compression stress S are required these days.

In that manner, the load given to cover glasses is generated in various situations. As a result, cover glasses may be damaged, but the damage modes may differ depending on different situations. The present inventors analyzed the damage modes, and have found that the damage modes are grouped into the following four:

### (A) Front Side Periphery of Cover Glass

This phenomenon often occurs owing to collision of the periphery of a mobile device with a small object in dropping of the mobile device onto the ground, etc.

### (B) Back Side Periphery of Cover Glass

This phenomenon often occurs owing to collision of the periphery of a mobile device with a large object in dropping of the mobile device onto the ground, etc.

### (C) Back Side Main Surface of Cover Glass

This phenomenon often occurs owing to collision of the main surface of a mobile device with a nearly spherical object having a large radius of curvature, in dropping of the mobile device onto the ground, etc.

### (D) Front Side Main Surface of Cover Glass

This phenomenon often occurs owing to collision of the main surface of a mobile device with sharp sand, stones or the like existing on the ground or the like, in dropping of the mobile device onto the ground, etc.

Of the above, regarding the damage to (D), the present inventors have found out the following: Briefly, the damage starting from the front side main surface of cover glass is often caused when the main surface collides with a sharp object, and therefore results from the arrival of the cracking having pierced the surface compressive stress layer to the internal tensile stress layer. Consequently, even though the value of the surface compressive stress layer S is enlarged as proposed above, the damage to (D) is still difficult to reduce. In addition, even though the thickness of the surface compressive stress layer DOL is increased, the value of DOL would be at most 100 μm or so, and therefore it is still impossible to prevent the cracking caused by collision with a sharp object from piercing the surface compressive stress layer.

While small and large display devices have become utilized more broadly as in the above, the situation of cover glass damage comes to be much diversified as compared to the time when display devices are not so much utilized.

An object of the present invention is to provide a chemically strengthened glass sheet, a cover glass and a touch sensor-attached chemically strengthened glass which are hardly damaged and are appropriately responsive to such diversified utilization ways. For describing diversified damage conditions, a case of cover glass is specifically mentioned here, but the present invention is not limited thereto.

### Means for Solving the Problems

While investigating and studying the damage modes of the cover glass and the touch sensor-attached chemically strengthened glass that are used in display devices, the present inventors have found that the damage modes of the cover glass and others can be grouped into the above four, and have reached the present invention. The four damage modes are described in more detail hereinunder with reference to FIG. 15. In this description, a touch sensor-attached chemically strengthened glass means a chemically strengthened glass with a touch sensor mounted thereon, and a simple expression of chemically strengthened glass means a chemically strengthened glass itself with no touch sensor mounted thereon.

### (A) Front Side Periphery of Cover Glass

The damage to the front side periphery of cover glass is referred to as Hertz fracture (Hertz crack), which, when the edge of cover glass or the like is given impact, starts from a conical fracture face as an origination that forms on the impact surface (edge surface) of the cover glass or the like and is referred to as a Hertz cone. The resistance to the damage to the front side periphery of cover glass can be measured according to the Hertz cracking test and the four-point bending test to be mentioned below.

### (B) Back Side Periphery of Cover Glass

The damage to the back side periphery of cover glass is, when the edge of cover glass is given impact, to start from the flaw as an origination that is generated by the internal tensile stress occurring on the non-impact surface (edge surface) opposite to the impact surface. The resistance to the damage to the back side periphery of cover glass can be measured according to the Hertz cracking test and the four-point bending test to be mentioned below.

### (C) Back Side Main Surface of Cover Glass

The damage to the back side main surface of cover glass is, when the main surface of cover glass is given impact, to start from the flaw as an origination that is generated by the internal tensile stress occurring on the non-impact surface (edge surface) opposite to the impact surface. The resistance to the damage to the back side main surface of cover glass can be measured according to the falling ball test to be mentioned below.

### (D) Front Side Main Surface of Cover Glass

The damage to the front side main surface of cover glass is one owing to slow cracking which is, when the main surface of cover glass is given impact, to start from the flaw piercing the compressive stress layer as an origination to thereby cause cracking of glass at a relatively slow speed (hereinafter the glass cracking mode of the type is referred to as slow cracking). The slow cracking generally gives few broken pieces and is most typically a phenomenon of such that one crack extends from the fracture origination and touch sensor-attached chemically strengthened glass is thereby broken into two pieces. The crack of this type is typically seen in cover glasses and others of display devices having a touch panel function, such as mobile phones, personal digital assistances (PDAs), tablet PCs, etc.

Mobile phones and personal digital assistances are carried around by users, and are therefore at high risk of impact application thereto owing to dropping or the like, and are also at high risk of contact with a substance that may pierce the compressive stress layer thereof to form flaws. Regarding tablet PCs, the size thereof is typically 150 to 350 mm×100 to 250 mm, and the weight thereof is from 150 to 1000 g. In other words, though the size is large and the weight is high, such tablet PCs are carried around by users. Use cases include, for example, a case where a tablet PC is stood up in a kitchen for cooking while looking at the recipe on the PC screen, and a case where a tablet PC is stood up in a conference room for meeting while looking at the data on the PC screen.

Consequently, when mobile phones, personal digital assistances or the like are dropped, or when tablet PCs are erroneously dropped or knocked over, some flaws piercing the surface compressive stress layer may be often formed and slow cracking would frequently occur.

Here, the slow cracking occurring on the cover glass of a tablet PC is described as an example of slow cracking referred to herein, with reference to FIG. 16 to FIG. 22.

A tablet PC is so configured that a nearly rectangular frame is arranged to surround the image display area, and a cover glass is supported on the frame. As shown in FIG. 16, when a tablet PC1 is dropped onto the ground (asphalt, concrete, etc.) and is brought into contact with the sand 5 or the like on the small stone 4 in the asphalt/concrete 3 while the cover glass 2 is kept facing downside, then a compressive stress acts on the fracture origination O, and a tensile stress acts on the image display area side of the cover glass (FIG. 17A). Subsequently, the tensile stress acts on the fracture origination O, and the crack C extends and the cover glass 2 is thereby broken (FIG. 17B). The fracture origination may be generated in the center part of the cover glass, but the flexure of the cover glass may be restrained by the frame so that the stress occurring at the fracture origination may be large and the fracture origination is frequently generated in a part of the region supported by the frame. The type of cracking of the cover glass 2 occurs not only in a case where devices are dropped on the ground but also in other cases where devices are dropped on the floors of conference rooms, living rooms, kitchens, etc.

FIG. 18A is a photograph of a tablet PC where slow crackings formed, FIG. 18B is the closeup picture of the fracture origination as seen from the top, and FIG. 18C is the picture of the fracture origination as seen from the side.

The cover glass cracking in this case is, as obvious from the fracture face of FIG. 18C, such that the flaw having a depth larger than the depth of the compressive stress layer is the fracture origination. In FIGS. 18A and 18B, one crack extends from the fracture origination, and the cover glass is thereby broken into two pieces. The fracture face shown in FIG. 18C is further observed. Around the fracture origination that is deeper than the depth of the compressive stress layer, there is seen a mirror that is smooth like mirror and has a long mirror radius.

FIG. 19 is a view schematically showing the fracture cross-section of FIG. 18C. The fracture cross-section reflects the fracture process, or that is, reflects the fracture origination, the fracture traveling direction, whether the fraction has developed gently or rapidly, etc. The fracture cross-section analysis of the slow cracking has revealed that the fracture of the mirror having a long mirror radius is developed by a small stress, and such a smooth fracture cross-section means that the crack has grown slowly at a far lower speed than the sound speed. Consequently, from the fracture face of FIG. 18C, it can be seen that, in the cover glass, after the origination deeper than the depth of the compressive stress layer has been formed, the crack has slowly grown, and the fracture has been developed by a small stress. The cover glass thus having been cracked in such a slow cracking mode gives a few to (as the case may be) several tens of cracked pieces. Typically, from 2 to 20 pieces are formed in the case. The cases of FIGS. 18A and 18B where one crack extended from the fracture origination and the cover glass was thereby broken into two pieces are typical examples of slow cracking.

More microscopically, whether it is slow cracking or not can be discerned as follows: First, one that could not provide a fracture origination cannot be said to be slow cracking. The area around the fracture origination is observed, and when it is confirmed that the flaw piercing the compressive stress layer, or that is, the flaw deeper than the depth of the compressive stress layer is a fracture origination, then the case corresponds to slow cracking. In addition, a case where the mirror radius is long and the fracture cross-section is a mirror not providing any mist or hackle corresponds to slow cracking.

Next, for comparison with slow cracking, another cracking mode of cover glass that does not correspond to slow cracking (hereinafter this is referred to non-slow cracking” is described. As the non-slow cracking, described here is a case of cracking of cover glass caused by pressing a Knoop indenter against the glass surface. FIG. 20 is a photograph of the fracture origination of a cover glass cracked in a non-slow cracking mode, as seen from the side of the cover glass. FIG. 21 is a view graphically showing the fracture cross-section of FIG. 20.

The fracture cross-section of the non-slow cracking is observed. A fracture origination is formed inside the compressive stress layer, and a mirror having a short mirror radius and smooth like a mirror is seen therearound. Further around the mirror, there exists a mist surface (mist). The fracture cross-section analysis of the non-slow cracking has revealed that the fracture of the mirror having a short mirror radius is developed by a large stress, and that the crack has grown rapidly in the mist surface. Consequently, from the fracture face of FIG. 20, it can be seen that, in the cover glass, after the fracture origination shallower than the depth of the compressive stress layer has been formed, the fracture has been rapidly developed by a large stress, and the crack has thus grown rapidly. As shown in FIG. 22, the cover glass thus having been cracked in such a non-slow cracking mode is to have multiple cracks each extending like a cobweb and gives multiple (20 or more) cracked pieces (hereinafter the cracking mode of the type is referred to as spider cracking). In that manner, it can be seen that fracture occurs in a quite different mode between slow cracking and non-slow cracking.

In the slow cracking mode, the fracture origination forms in the region over the compressive stress layer, or that is, inside the internal tensile stress layer (the depth of the flaw is typically from tens to hundreds micrometers, and the chemically strengthened compressive stress layer is from a few to tens micrometers), and therefore in a display device where slow cracking may frequently form, it is necessary to select chemically strengthened glass having a mechanical characteristic feature resistant to slow cracking. The resistance to the slow cracking (damage to the front side main surface of cover glass) can be measured according to the pyramid-shaped diamond indenter test and the sand paper falling ball test to be mentioned below. The non-slow cracking is a fracture mode that is forcedly generated for comparison to the slow cracking, and is not grouped into the above-mentioned four damage modes.

The chemically strengthened glass sheet, the cover glass, the touch sensor-attached chemically strengthened glass and the display device of the present invention can be prevented from being damaged by all the factors of the above-mentioned four damage modes. The present invention provides the aspects mentioned below.

(1) A chemically strengthened glass sheet, which has front and back main surfaces and an edge surface between the front and back main surfaces,

wherein the chemically strengthened glass sheet has a surface compressive stress of 800 MPa or more, and an internal tensile stress of 42 MPa or less,

the edge surface has a chamfered part, and a part of the chamfered part where a distance from the main surface adjacent to the chamfered part toward a sheet thickness direction is ⅕ or less of a sheet thickness has no latent flaw deeper than 20 μm, and the chemically strengthened glass sheet contains, in terms of mol % on the basis of oxides, from 56 to 75% of SiO₂, from 5 to 20% of Al₂O₃, from 8 to 22% of Na₂O, from 0 to 10% of K₂O, from 0 to 14% of MgO, from 0 to 5% of ZrO₂ and from 0 to 5% of CaO.

(2) The chemically strengthened glass sheet according to (1), which has the surface compressive stress of 850 MPa or more.
(3) The chemically strengthened glass sheet according to (1), which has the internal tensile stress of 35 MPa or less.
(4) The chemically strengthened glass sheet according to (3), which has the internal tensile stress of 30 MPa or less.
(5) The chemically strengthened glass sheet according to (1), which has a thickness of a surface compressive stress layer of from 15 to 40 μm.
(6) The chemically strengthened glass sheet according to (5), which has the thickness of the surface compressive stress layer of from 20 to 35 μm.
(7) The chemically strengthened glass sheet according to (1), which has a sheet thickness of 0.8 mm or less.
(8) The chemically strengthened glass sheet according to (1), wherein a total content of SiO₂, Al₂O₃, Na₂O, MgO and B₂O₃ is 98% or more.
(9) The chemically strengthened glass sheet according to (1), wherein a total content of SiO₂, Al₂O₃, Na₂O and MgO is 98% or more.
(10) The chemically strengthened glass sheet according to (1), wherein a difference resulting from subtracting an Al₂O₃ content from a Na₂O content is less than 5%.
(11) The chemically strengthened glass sheet according to (1), wherein the part of the chamfered part where the distance from the main surface adjacent to the chamfered part toward the sheet thickness direction is ⅕ or less of the sheet thickness has no latent flaw of 10 μm or deeper.
(12) The chemically strengthened glass sheet according to (1), wherein a touch sensor is provided on the main surface.
(13) A chemically strengthened glass sheet, which has front and back main surfaces and an edge surface between the front and back main surfaces,

wherein the chemically strengthened glass sheet has a surface compressive stress of 800 MPa or more, and an internal tensile stress of 42 MPa or less,

the edge surface has a chamfered part, and a part of the chamfered part where a distance from the main surface adjacent to the chamfered part toward a sheet thickness direction is ⅕ or less of a sheet thickness has no latent flaw deeper than 20 μm, and

the chemically strengthened glass sheet contains, in terms of mol % on the basis of oxides, from 60 to 75% of SiO₂, from 11 to 15% of Al₂O₃, from 11 to 16% of Na₂O, from 0 to 5% of K₂O, from 0 to 10% of MgO, from 0 to 1% of ZrO₂ and from 0 to 5% of CaO.

(14) The chemically strengthened glass sheet according to (13), which has the surface compressive stress of 850 MPa or more.
(15) The chemically strengthened glass sheet according to (13), which has the internal tensile stress of 35 MPa or less.
(16) The chemically strengthened glass sheet according to (15), which has the internal tensile stress of 30 MPa or less.
(17) The chemically strengthened glass sheet according to (13), which has a thickness of a surface compressive stress layer of from 15 to 40 μm.
(18) The chemically strengthened glass sheet according to (17), which has the thickness of the surface compressive stress layer of from 20 to 35 μm.
(19) The chemically strengthened glass sheet according to (13), which has a sheet thickness of 0.8 mm or less.
(20) The chemically strengthened glass sheet according to (13), wherein a total content of SiO₂, Al₂O₃, Na₂O, MgO and B₂O₃ is 98% or more.

### Advantage of the Invention

According to the present invention, there are provided a chemically strengthened glass sheet, a cover glass, a touch sensor-attached chemically strengthened glass and a display device that are resistant to various damage conditions.

### BRIEF DESCRIPTION OF THE DRAWINGS

FIG. 1 is a partly-cut sectional side view of a chemically strengthened glass sheet according to the first embodiment of the present invention.

FIG. 2 is a partly-cut sectional side view of a chemically strengthened glass sheet according to the first embodiment of the present invention.

FIG. 3 is a partly-cut sectional side view of a chemically strengthened glass sheet according to the first embodiment of the present invention.

FIG. 4 is a sectional side view showing a production method for a chemically strengthened glass sheet according to the second embodiment of the present invention.

FIG. 5 is a sectional side view showing a production method for a chemically strengthened glass sheet according to the second embodiment of the present invention.

FIG. 6 is a sectional side view showing a production method for a chemically strengthened glass sheet according to the second embodiment of the present invention.

FIG. 7 is a sectional side view showing a production method for a chemically strengthened glass sheet according to the third embodiment of the present invention.

FIG. 8 is a sectional side view showing a production method for a chemically strengthened glass sheet according to the third embodiment of the present invention.

FIG. 9 is a sectional side view showing a production method for a chemically strengthened glass sheet according to the third embodiment of the present invention.

FIG. 10 is a sectional side view showing a production method for a chemically strengthened glass sheet according to the fourth embodiment of the present invention.

FIG. 11 is a sectional side view showing a production method for a chemically strengthened glass sheet according to the fourth embodiment of the present invention.

FIG. 12 is a plan view to constitute the main part of a touch sensor-attached chemically strengthened glass according to the fifth embodiment of the present invention.

FIG. 13 is an A-A line cut cross-sectional view of FIG. 12.

FIGS. 14A to 14I are views of explaining a production method for a touch sensor-attached chemically strengthened glass according to the sixth embodiment of the present invention.

FIG. 15 is a view of explaining four damage modes occurring in cover glass, etc.

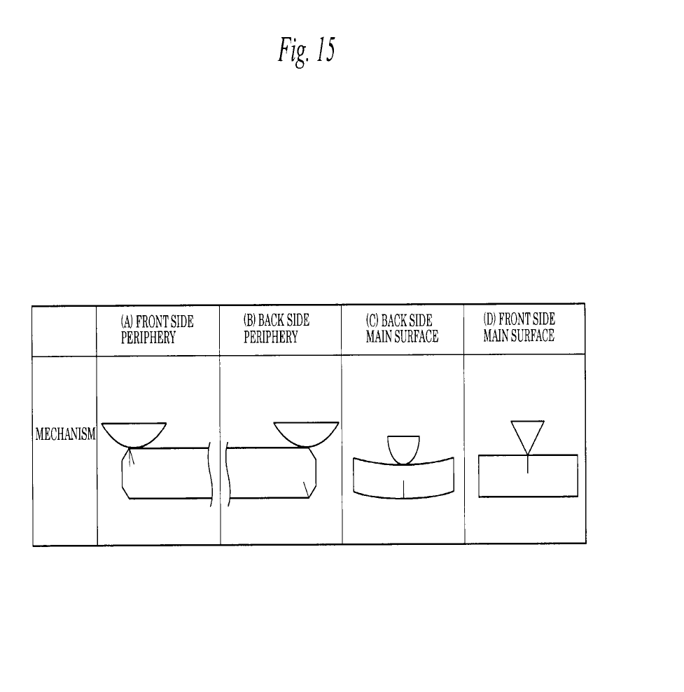

FIG. 16 is a graphical view showing a situation of slow cracking that may occur in a cover glass when a tablet PC is dropped down.

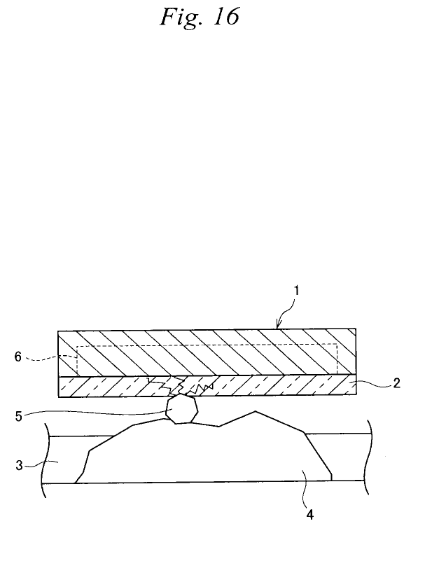

FIGS. 17A to 17B are views graphically showing a mechanism of slow cracking, in which FIG. 17A is a view showing a fracture origination and FIG. 17B is a view showing a crack.

FIG. 18A is a photograph of a tablet PC with a touch sensor function, in which slow cracking has occurred; FIG. 18B is an enlarged photograph showing a fracture origination as viewed from the above; FIG. 18C is a photograph of a fracture origination as viewed from the side.

FIG. 19 is a view graphically showing the fracture face of FIG. 18(c).

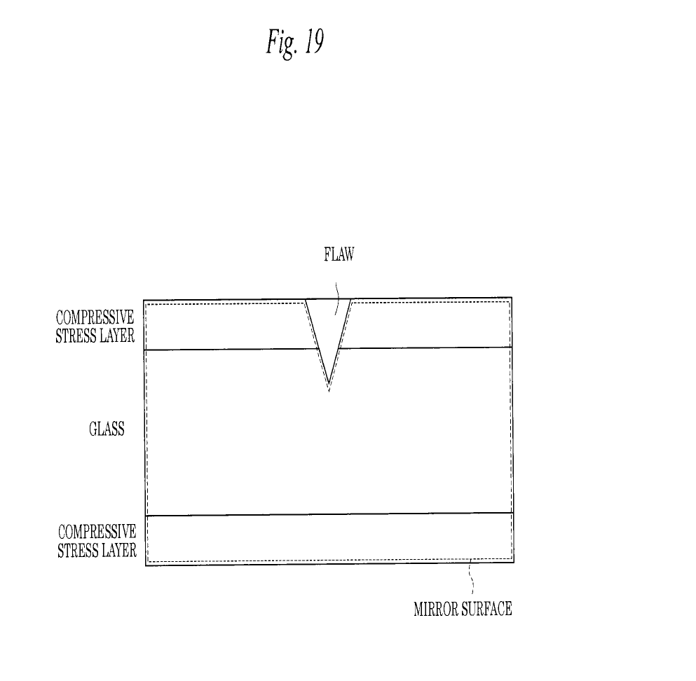

FIG. 20 is a photograph of a fracture origination of a cover glass cracked in a non-slow cracking mode, as seen from the side of the cover glass.

FIG. 21 is a view graphically showing the fracture cross-section of FIG. 20.

FIG. 22 is a photograph of a cover glass in which spider cracking has occurred.

FIG. 23 is a schematic view of a sand paper falling ball test.

FIGS. 24A to 24B are views graphically showing a mechanism of cracking of a chemically strengthened glass in the sand paper falling ball test of FIG. 23, in which FIG. 24A is a view showing a fracture origination, and FIG. 24B is a view showing a crack.

FIG. 25A is a photograph of a cover glass that has been cracked in a slow cracking mode, for which a chemically strengthened glass is arranged on a base formed of granite, and while the top surface of the chemically strengthened glass is kept in contact with the abrasive surface of a sand paper of P30, a stainless steel ball having a diameter of 0.75 inches and a weight of 4 g is dropped down thereon; and FIG. 25B is a photograph of the fracture origination viewed from the side.

FIG. 26A is an enlarged photograph of the sand paper of P30, FIG. 26B is an enlarged photograph of asphalt/concrete; and FIG. 26C is a graph showing the tip angle distribution of the P30 sand paper and the tip angle distribution of the sand.

FIG. 27 is a graph showing the relationship between the internal tensile stress T and the load F₅₀ in a four-sided pyramid indenter indentation test.

FIG. 28 is a graph showing the relationship between the surface compressive stress S and the bending strength in a four-point bending test.

FIG. 29 is a graph showing the relationship between the surface compressive stress S and the fracture energy in a falling ball test.

FIG. 30 is a graph showing the relationship between the thickness of the surface compressive stress layer DOL and the bending strength in a four-point bending test.

FIG. 31 shows Weibull plots of indicating the four-point bending strength of chemically strengthened glass sheets of one embodiment of the present invention.

FIG. 32A is a graph showing the results of a Hertz cracking test; FIG. 32B is a graph showing the results of a back side cracking test; FIG. 32C is a graph showing the results of a falling ball test; and FIG. 32D is a graph showing the results of a sand paper falling ball test.

FIG. 33A is a schematic view of an existing display device having a touch panel function; and FIG. 33B is a schematic view of a 2-in-1 type display device.

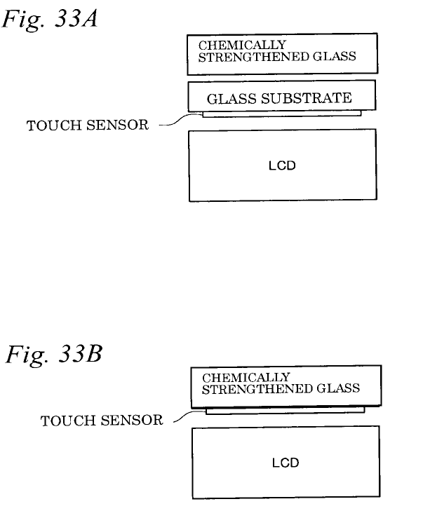

### MODE FOR CARRYING OUT THE INVENTION

As described above, the present inventors have found that the damage modes of cover glass can be grouped into the following four, (A) front side periphery of cover glass, (B) back side periphery of cover glass, (C) back side main surface of cover glass, (D) front side main surface of cover glass, and have found out a chemically strengthened glass capable of exhibiting a high strength for all of those four damage modes.

From the viewpoint of the damage to (D), the degree of damage can be reduced by lowering the internal tensile stress T to 42 MPa or less. Preferably, the internal tensile stress T is 40 MPa or less, more preferably 37 MPa or less, even more preferably 35 MPa or less, still more preferably 34 MPa or less, and especially preferably 30 MPa or less. When the internal tensile stress T is too small, then the surface compressive stress S and the depth of the compressive stress layer could not be enlarged and therefore, the strength could not be increased as a whole. Consequently, the lower limit of the internal tensile stress T is 3 MPa or more, preferably 8 MPa or more, more preferably 9 MPa or more, even more preferably 10 MPa or more.

Regarding the resistance of glass from the viewpoint of the damage to (D), it is important what type of substance would be brought into contact with glass, from the viewpoint as to whether or not flaws may remain on the glass surface. In particular, when glass is brought into contact with a hard substance such as sand (mainly formed of SiO₂ or the like), then the glass surface would be dented to provide indentations and cracks resulting therefrom as well as scratches remaining thereon. At this time, the angle of the substance to be brought into contact with glass is important from the viewpoint as to whether or not cracks would be generated from the flaws.

Heretofore, the resistance to cracking of cover glass or the like has been evaluated according to a test using a Vickers' indenter. However, we, the present inventors have considered that the level of resistance to cracking should be determined in a case of using a sharper indenter. Concretely, using multiple samples having been processed for chemical strengthening so as to have a different internal tensile stress T, a load was applied to each sample using a Vickers' hardness tester provided with a pyramid-shaped diamond indenter having a vertex angle of 110°, whereupon the load F₅₀ (unit: kgf) under which the probability of sample destruction is 50% was read on the meter. In the measurement test, used was a Vickers' hardness tester by Future-tech, FLC-50V.

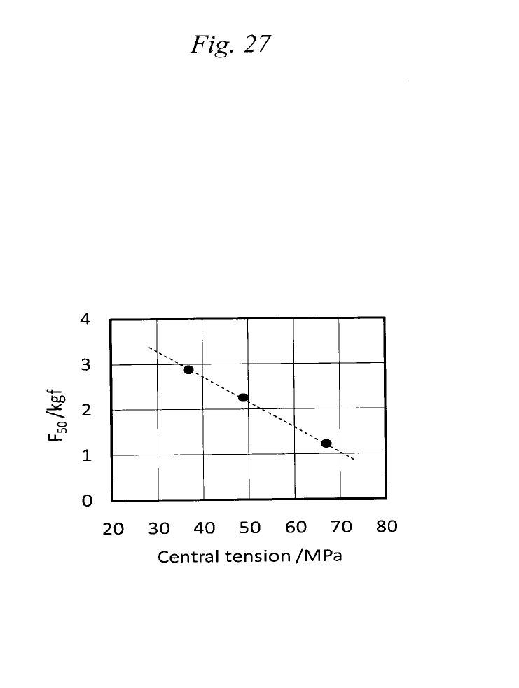

The relationship between the internal tensile stress T and F₅₀ in the four-sided pyramid indenter indentation test is shown in FIG. 27. With increasing in the internal tensile stress T more, the sample was broken under a smaller load. The measurement results confirm that, for preventing the damage to (D), the internal tensile stress T is preferably lower.

In addition, the present inventors have found out a sand paper falling ball test as described below apart from the pyramid-shaped diamond intender test, as a method of reproducing the damage to the front side main surface of cover glass (D).

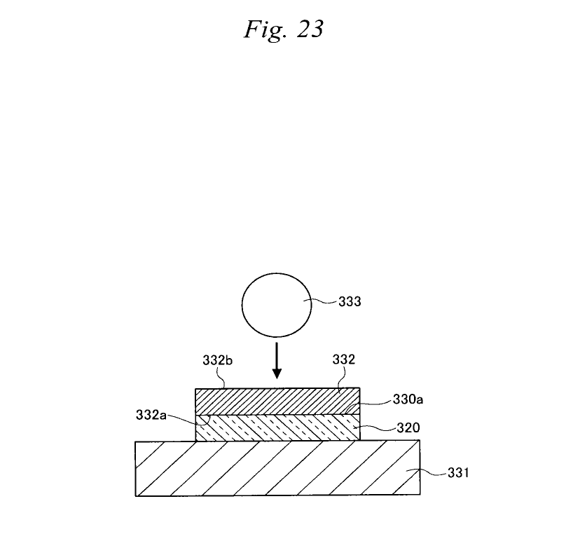

The sand paper falling ball test is as shown in FIG. 23. A chemically strengthened glass 320 with a compressive stress layer formed on the surface thereof is arranged on a base 331, the chemically strengthened glass 320 is kept in contact with the sand surface 332a of a sand paper 332 containing an abrasive having a size larger than the depth of the compressive stress layer, and a ball 333 such as an iron ball or the like is dropped down thereon from the above. At this time, the sand paper 332 is preferably arranged above the chemically strengthened glass 320, and the top surface 330a of the chemically strengthened glass 320 is kept in contact with the sand surface 332a of the sand paper 332, and the ball 333 is dropped down onto the surface 332b opposite to the sand surface 332a of the sand paper 332.

As the base 331, preferred is one formed of a hard stone such as granite. Accordingly, the stress salvation could be excluded like in the region of the cover glass supported by a frame where a flaw to be a fracture origination may be readily formed. However, regarding the material of the base 331, the elastic modulus and the flexibility thereof could be varied in accordance with the intended use, and a straight material, glass, a center-hollowed frame or the like may be suitably selected for the material.

Not limited to abrasive-coated paper (abrasive paper, JIS R6252:2006), the sand paper includes any one produced by coating a substrate with an abrasive by the use of an adhesive, and any others corresponding thereto, for example, abrasive-coated texture (JIS R6251:2006), waterproof abrasive paper (JIS R6253:2006).

Depending on the particle size of the abrasive contained therein, the sand paper 332 includes P12 to P2500 (JIS R6252, 2006). The abrasive is typically alumina or silicon carbide. In case where the particle size of the sand contained in asphalt/concrete is presumed to be from 0.06 mm to 1 mm, the particle size of the abrasive of P30 to P600 contained in the sand paper 332 almost corresponds thereto.

For example, when the depth of the compressive stress layer is presumed to be 30 μm, then sand paper of P30 (D₃: 710 μm), P100 (D₃: 180 μm), P320 (d₃: 66.8 μm), P600 (d₃: 43.0 μm) or the like may be selected as the sand paper that contains an abrasive having a larger size than the depth of the compressive stress layer.

The weight of the material of the ball 333 may be varied in accordance with the intended use, and typically used here is a stainless ball made of stainless steel having a weight of from 4 to 150 g.

In that manner, when the ball 333 is dropped down onto the chemically strengthened glass 320 arranged on the base 331, then a fracture origination O is generated at the site deeper than the compressive stress layer on the side of the top surface 330a of the chemically strengthened glass 320, by the abrasive contained in the sand paper 332.

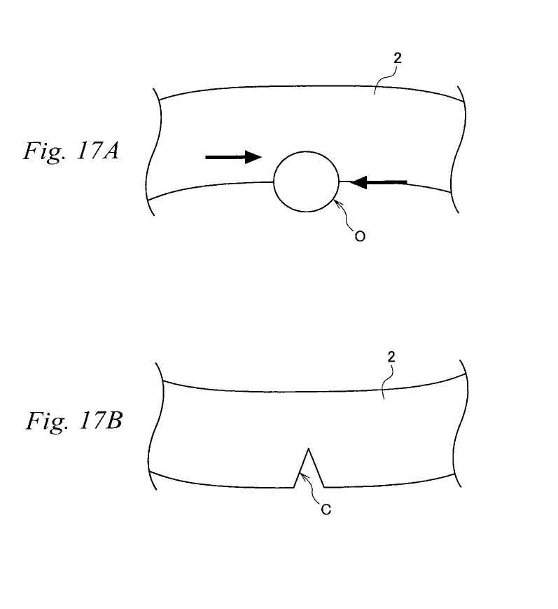

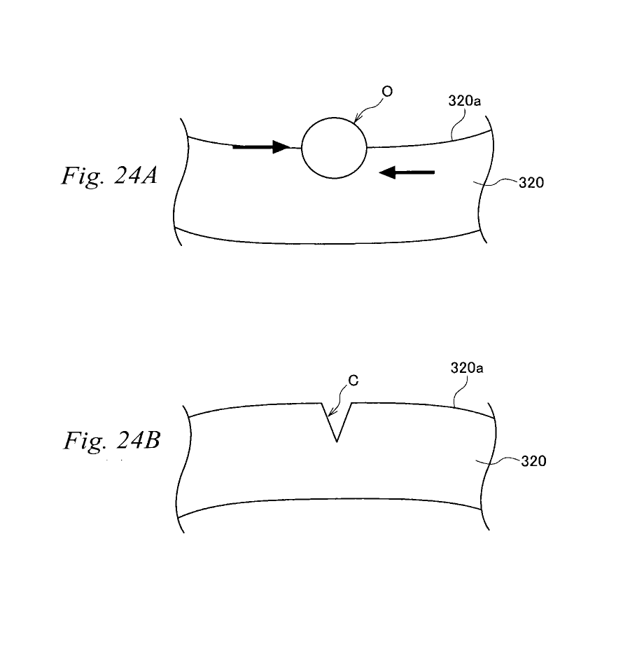

At this time, a compressive stress acts on the fracture origination O, and a tensile stress acts therearound (FIG. 24A). Subsequently, a tensile stress acts on the fracture origination O and a crack C extends, and the cover glass is thereby broken (FIG. 24B). Specifically, though there is a difference in that the fracture origination is on the top surface or the bottom surface, the cracking occurs here in the same mechanism as that of the slow cracking described in FIGS. 17A and 17B.

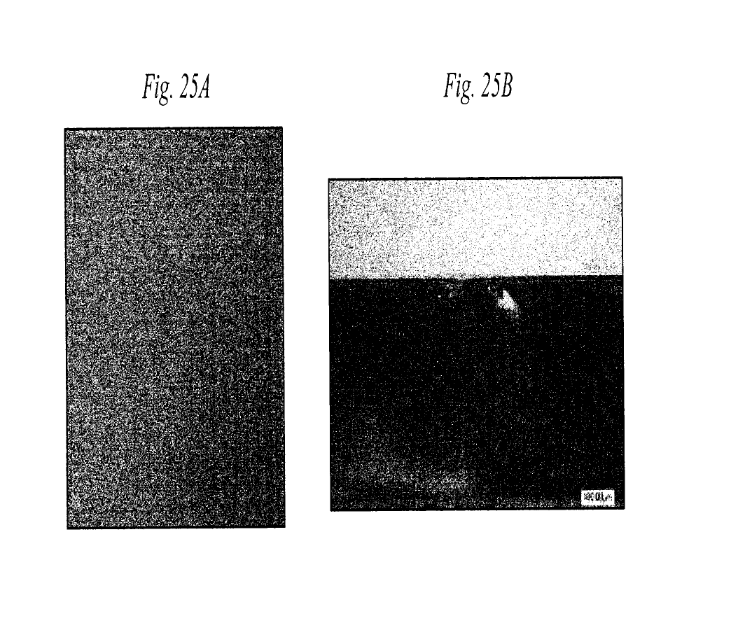

FIG. 25A is a photograph of a cover glass with slow cracking occurring therein, for which a chemically strengthened glass 320 was arranged on a base of granite, and while the top surface of the chemically strengthened glass 320 was kept in contact with the sand surface of a sand paper 332 of P30, a stainless steel ball 333 having a diameter of 0.75 inches and a weight of 4 g was dropped down thereon from a height of 17 cm. FIG. 25B is a photograph of the fracture origination of FIG. 25A, as viewed from the side.

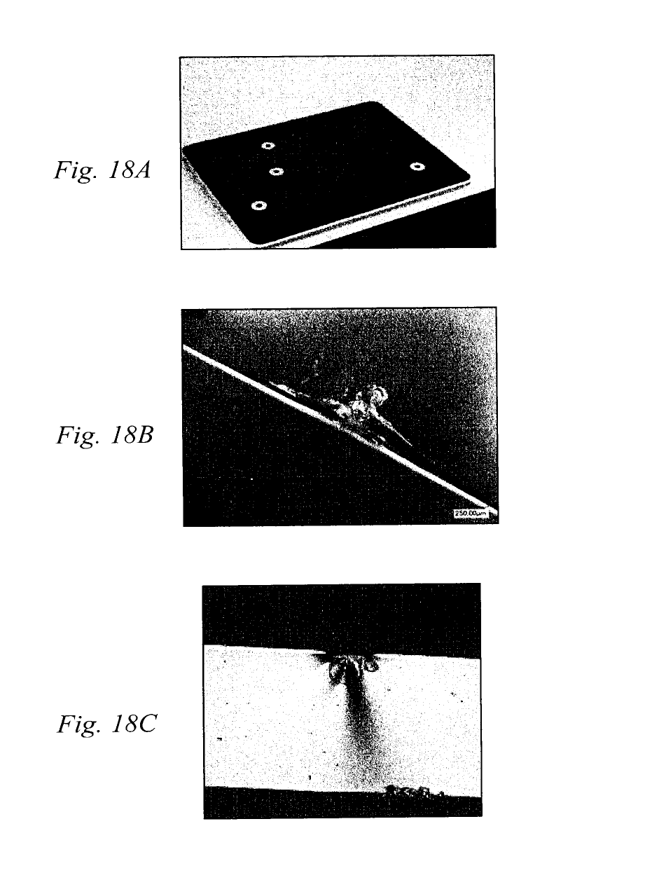

In the chemically strengthened glass, one crack extended and the cover glass was thereby broken into two. FIG. 25B shows the same fracture face as in FIG. 18C, and it can be seen that the cracking occurred here in the same mechanism as that of slow cracking.

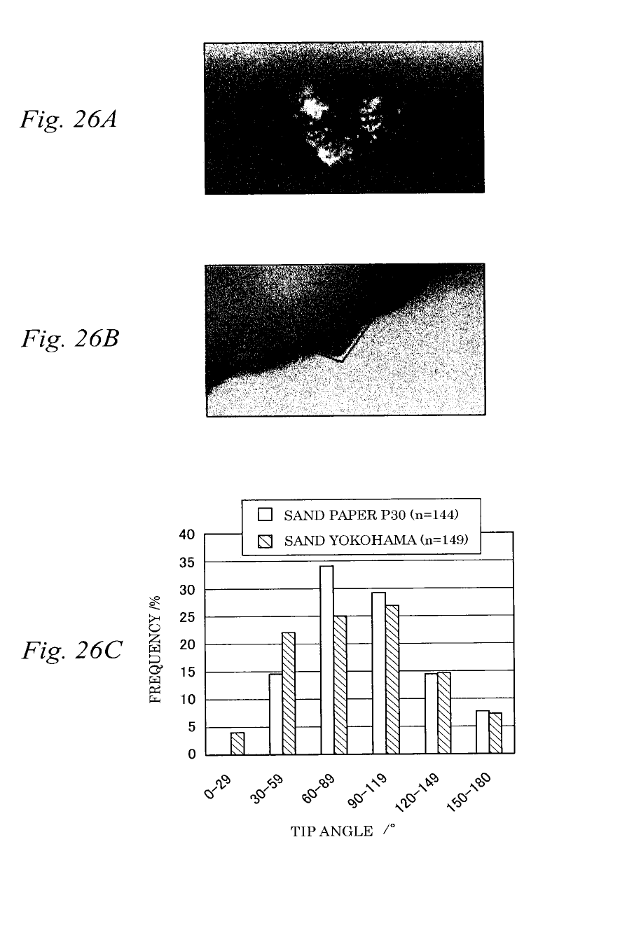

FIG. 26A is an enlarged photograph of the sand paper of P30, FIG. 26B is an enlarged photograph of asphalt/concrete (collected in Yokohama), and FIG. 26C is a graph showing the tip angle distribution of the P30 sand paper and the tip angle distribution of the sand. FIG. 26C shows the data of the sand paper analyzed at 144 sites and the sand analyzed at 149 sites therein, in which the horizontal axis indicates the tip angle of the sand paper or the sand and the vertical axis indicates the frequency. In the present invention, in view of the proximity between the shape of the alumina contained in the P30 sand paper as the abrasive therein and that of the pebble or the like contained in asphalt/concrete, the P30 sand paper was selected.

In the sand paper falling ball test in the present invention, a chemically strengthened glass was arranged on the base of granite, and while the top surface of the cover glass was kept in contact with the sand surface of the P30 (JIS R6252, 2006) sand paper, a stainless steel ball having a diameter of 0.75 inches and a weight of 29 g was dropped thereonto from the above.

The measurement condition for the samples is as follows. Five types of glass samples A4 to E4 of the following five glass materials A to E were cut into a size of 50 mm×50 mm, and polished to prepare 20 sheets of chemically strengthened glass. These 20 sheets of glass was individually arranged on a base of granite, while the top surface of the glass was kept in contact with the sand surface of a P30 (JIS 86252, 2006) sand paper, a stainless steel ball having a diameter of 0.75 inches and a weight of 29 g was dropped down thereon from the above, whereupon the simple average of the height of the falling ball in fracture was calculated to be the average fracture height.

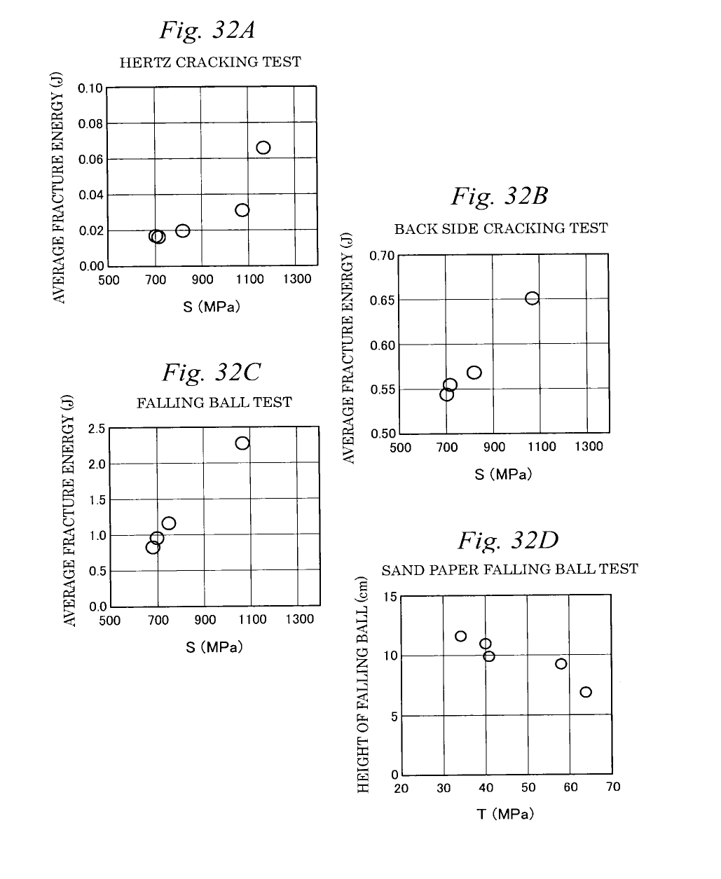

Glass A4 to E4 each have the properties as shown in Table 1. Table 1 and FIG. 32D show the test results of the glasses in the sand paper falling ball test. In Table 1, T means an internal tensile stress, and S means a surface compressive stress. The glass A1 to A4 were formed of the glass material A, the glass B1 to B4 were formed of the glass material B, the glass C1 to C4 were formed of the glass material C, the glass D1 to D4 were formed of the glass material D, and the glass E1 to E4 were formed of the glass material E. These were cut in a size of 50 mm×50 mm, then polished and chamfered on the C plane thereof with a wheel of #600. Subsequently, each glass was chemically strengthened.

The glass material A has the following composition.

| | |
|---|---|
| SiO₂: | 72.5 mol % |
| Al₂O₃: | 6.2 mol % |
| Na₂O: | 12.8 mol % |
| MgO: | 8.5 mol % |

The glass material B has the following composition.

| | |
|---|---|
| SiO₂: | 61.5 mol % |
| Al₂O₃: | 13 mol % |
| Na₂O: | 17 mol % |
| MgO: | 8 mol % |
| K₂O: | 0.5 mol % |

The glass material C has the following composition.

| | |
|---|---|
| SiO₂: | 68 mol % |
| Al₂O₃: | 10 mol % |
| Na₂O: | 14 mol % |
| MgO: | 8 mol % |
| K₂O: | 4 mol % |

The glass material D has the following composition.

| | |
|---|---|
| SiO₂: | 64 mol % |
| Al₂O₃: | 8 mol % |
| Na₂O: | 12.5 mol % |
| K₂O: | 4 mol % |
| MgO: | 11 mol % |
| ZrO₂: | 0.5 mol % |

The glass material E has the following composition.

| | |
|---|---|
| SiO₂: | 66.7 mol % |
| Al₂O₃: | 10.8 mol % |
| Na₂O: | 13.2 mol % |
| K₂O: | 2.4 mol % |
| MgO: | 6.2 mol % |
| CaO: | 0.6 mol % |

TABLE 1

| Type of Glass | Glass A4 | Glass B4 | Glass C4 | Glass D4 | Glass E4 |
|---|---|---|---|---|---|
| Glass Material | A | B | C | D | E |
| Thickness of | 1.0 | 1.0 | 1.0 | 1.0 | 1.0 |
| Glass | | | | | |
| (mm) | | | | | |
| S | 701 | 1219 | 1065 | 753 | 733 |
| (MPa) | | | | | |
| DOL | 44.4 | 47.3 | 49 | 48.9 | 49.1 |
| (μm) | | | | | |
| T | 34 | 64 | 58 | 41 | 40 |
| (MPa) | | | | | |
| Height of | 11.6 | 6.8 | 9.2 | 9.9 | 10.9 |
| Falling Ball | | | | | |
| (cm) | | | | | |

Regarding the damage to the front side main surface of cover glass (D), FIG. 32D confirms that the height of the falling ball to cause damage is inversely proportional to the internal tensile stress T, and when the internal tensile stress T is smaller, then the height of the falling ball to cause damage is higher, or that is, the cover glass tends to be more hardly broken.

It may be considered that the damage to (A), (B) and (C) could be reduced by increasing as much as possible the value of the surface compressive stress S, and therefore the surface compressive stress of the glass sheet of the present invention is defined to be 800 MPa or more. From the viewpoint of the damage to (A), (B) and (C), the surface compressive stress S is preferably higher. The surface compressive stress S is preferably 850 MPa or more, more preferably 900 MPa or more, even more preferably 950 MPa or more, and is extremely preferably 1000 MPa or more.

For investigating the relationship between the resistance of glass and the surface compressive stress S thereof from the viewpoint of the damage to (A) and (B), multiple samples individually processed for chemical strengthening so as to have a different surface compressive stress S were prepared, and tested for the bending strength thereof according to a four-point bending test (JIS R1601), in which the distance between the two supporting points was 40 mm and the distance between the two loading points was 10 mm. For the test, used was Shimadzu's Autograph AGX-X.

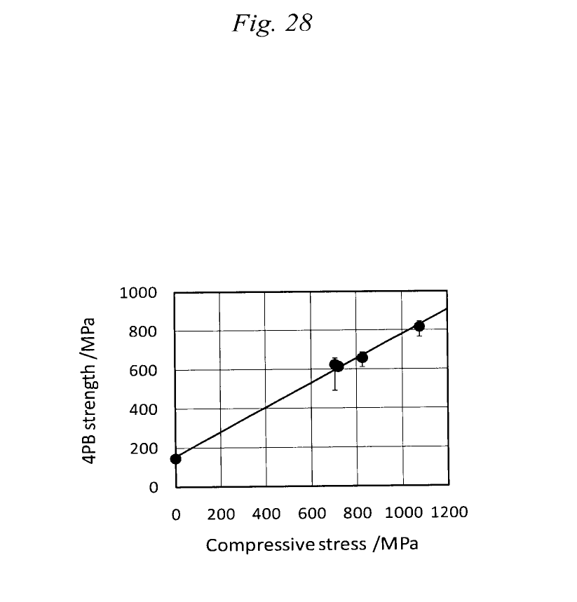

FIG. 28 is a graph showing the relationship between the surface compressive stress S and the bending strength in the four-point bending test. With the increase in the surface compressive stress S, the bending strength increases. The measurement results confirm that, for preventing the damage to (A) and (B), the surface compressive stress S is preferably higher.

In addition, regarding the damage to the front side periphery of cover glass (A), the strength at fracture can also be determined according to a Hertz cracking test.

The Hertz cracking test is as follows. A columnar rod formed of an ultrahard material and having a small diameter is made to collide with the edge of glass to thereby generate a Hertz stress on the front side of the edge of the glass to provide Hertz cracking thereon. From the impact energy of the columnar rod (collision energy J=height m×weight kg×9.8 m/s²), the resistance to the damage to (A) can be determined.

The measurement condition is as follows. Glass A1 to E1 of five types of the above-mentioned glass materials A to E were cut in a size of 50 mm×50 mm, then polished and chamfered on the C plane thereof with a wheel of #600. Subsequently, each glass was chemically strengthened. The glass was arranged on a base, and an ultrahard pin having a diameter of 3 mm was made to collide with the edge surface of the glass in a motion of a pendulum so that the front side edge surface of the glass was cracked in a mode of Hertz cracking. This was repeated 20 times. The simple average of the impact energy of the columnar rod at fracture was calculated to be the average fracture energy.

Glass A1 to E1 each have the properties as shown in Table 2. Table 2 and FIG. 32A show the test results of glass in the Hertz cracking test.

TABLE 2

| Type of Glass | Glass A1 | Glass B1 | Glass C1 | Glass D1 | Glass E1 |
|---|---|---|---|---|---|
| Glass Material | A | B | C | D | E |
| Thickness of | 1.0 | 1.0 | 1.0 | 1.0 | 1.0 |
| Glass | | | | | |
| (mm) | | | | | |
| S | 719 | 1174 | 1075 | 825 | 705 |
| (MPa) | | | | | |
| DOL | 42.7 | 46 | 49 | 48.7 | 49.2 |
| (μm) | | | | | |
| Average | 0.016 | 0.066 | 0.031 | 0.019 | 0.017 |
| Fracture Energy | | | | | |
| (J) | | | | | |

Regarding the cracking at the back side periphery of cover glass of (B), the strength at fracture can also be determined according to a back side cracking test.

The back side cracking test is as follows. A columnar rod formed of an ultrahard material and having a large diameter is made to collide with the edge of glass to thereby generate an impact tensile stress on the back side of the edge of the glass to provide edge/back side cracking thereon. From the impact energy of the columnar rod (collision energy J=height m×weight kg×9.8 m/s²), the resistance to the damage to (B) can be determined.

The measurement condition is as follows. Glass A2 and C2 to E2 of four types of the above-mentioned glass materials A and C to E were cut in a size of 50 mm×50 mm, then polished and chamfered on the C plane thereof with a wheel of #600. Subsequently, each glass was chemically strengthened. The glass was arranged on a base, and an ultrahard pin having a diameter of 40 mm was made to collide with the edge surface of the glass in a motion of a pendulum so that the back side edge surface of the glass was cracked by the shock. This was repeated 20 times. The simple average of the impact energy of the columnar rod at fracture was calculated to be the average fracture energy.

Glass A2 and C2 to E2 each have the properties as shown in Table 3. Table 3 and FIG. 32B show the test results.

TABLE 3

| Type of Glass | Glass A2 | Glass C2 | Glass D2 | Glass E2 |
|---|---|---|---|---|
| Glass Material | A | C | D | E |
| Thickness of Glass | 1.0 | 1.0 | 1.0 | 1.0 |
| (mm) | | | | |
| S | 719 | 1075 | 825 | 705 |
| (MPa) | | | | |
| DOL | 42.7 | 49 | 48.7 | 49.2 |
| (μm) | | | | |
| Average Fracture | 0.56 | 0.65 | 0.57 | 0.54 |
| Energy | | | | |
| (J) | | | | |

Next, for investigating the relationship between the resistance of glass and the surface compressive stress S thereof from the viewpoint of the damage to (C), multiple samples individually processed for chemical strengthening so as to have a different surface compressive stress S were prepared, and tested to measure the fracture energy thereof in a falling ball test. In the falling ball test, a sample having a size of 50 mm×50 mm×0.7 mm was fixed, and a stainless steel ball having a weight of 130 g was dropped down onto the sample. From the impact energy of the stainless steel ball (collision energy J=height m×weight kg×9.8 m/s²), the resistance to the damage to (C) can be determined.

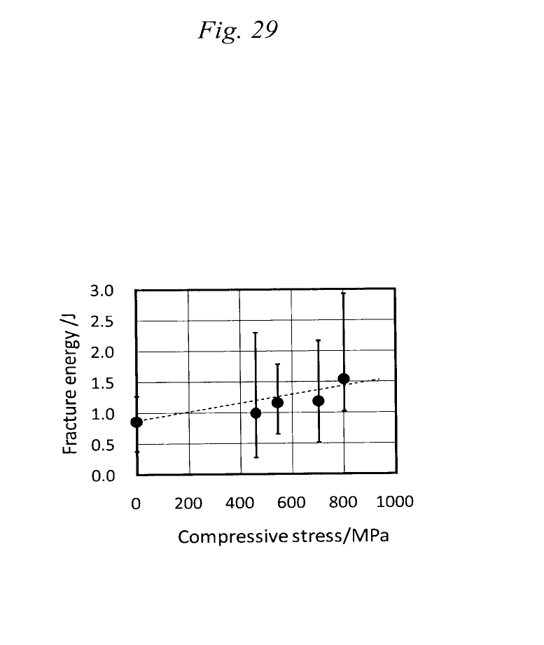

FIG. 29 is a graph showing the relationship between the surface compressive stress S and the fracture energy in the falling ball test. With the increase in the surface compressive stress S, the fracture energy increases. The measurement results confirm that, for preventing the damage to (C), the surface compressive stress S is preferably higher.

In addition, the falling ball test was carried out also under the following condition. Glass A3 and C3 to E3 of four types of the above-mentioned glass materials A and C to E were cut in a size of 50 mm×50 mm and then polished. Subsequently, each glass was chemically strengthened. The glass was arranged on a base of which the center part, 40 mm×40 mm had been hollowed out, and an iron ball having a diameter of 30 mm and a weight of 130 g was dropped down thereon so that the back side of the glass was broken by the shock. This was repeated 20 times. The simple average of the impact energy of the iron ball at fracture was calculated to be the average fracture energy.

Glass A3 and C3 to E3 each have the properties as shown in Table 4. Table 4 and FIG. 32C show the test results of glass in the falling ball test.

TABLE 4

| Type of Glass | Glass A3 | Glass C3 | Glass D3 | Glass E3 |
|---|---|---|---|---|
| Glass Material | A | C | D | E |
| Thickness of Glass | 1.0 | 1.0 | 1.0 | 1.0 |
| (mm) | | | | |
| S | 701 | 1065 | 753 | 683 |
| (MPa) | | | | |
| DOL | 44.4 | 49 | 48.9 | 52.3 |
| (μm) | | | | |
| Average Fracture | 0.97 | 2.28 | 1.17 | 0.84 |
| Energy | | | | |
| (J) | | | | |

Regarding these three damage modes, FIG. 32A to FIG. 32C confirm that the average fracture energy at cracking is proportional to the surface compressive stress, and with the increase in the surface compressive stress, the average fracture energy necessary for cracking increases more, or that is, the glass tends to be hardly broken.

Further, in particular, the present inventors have paid special attention to the damage to (A) and (B), and have found that the damage to (A) and (B), or that is, the damage to the periphery of a glass sheet comes to be more remarkable owing to the flaw remaining around the periphery, especially on the edge thereof. Consequently, the inventors have found that, in one embodiment of the glass sheet of the present invention where the edge of the glass sheet is provided with a chamfered part, when the etched surface of the sheet is so controlled as not to have a pit having a depth of 10 μm or more in the part where the distance from the main surface adjacent to the chamfered part toward the thickness direction is ⅕ or less of the thickness of the sheet, then the strength of the sheet of the type can be improved further more.

The inventors have further found that when the ratio of the depth of the latent flaw existing in the chamfered part to be the origination of the damage to the glass sheet, relative to the thickness of the surface compressive stress layer DOL, is controlled to be 0.9 or less, then the strength of the sheet can also be improved.

In this connection, in principle, it can be seen that a chemically strengthened glass sheet could satisfy the relationship of T=S×DOL/(t−2DOL), in which T is the internal tensile stress of the glass sheet, S is the surface compressive stress thereof, and DOL is the thickness of the surface compressive stress layer thereof. Accordingly, when the damage to (A), (B) and (C) is intended to be reduced as much as possible by increasing the value of the surface compressive stress S, then the value of the internal tensile stress T would increase and therefore the damage to (D) would be difficult to reduce.

Consequently, in one embodiment of the glass substrate in the present invention, the surface compressive stress S is from 850 to 1200 MPa, the thickness of the surface compressive stress layer DOL is from 20 to 35 the internal tensile stress T is from 3 to 42 MPa, and the sheet thickness is from 0.6 mm or more. Depending on the strengthening condition, the internal tensile stress T may be from 10 to 42 MPa, or may also be from 20 to 42 MPa, or even from 25 to 42 MPa in other embodiments. For use for cover glass and the like, the sheet thickness is more preferably 1.5 mm or less from the viewpoint of the weight of the sheet.

Also more preferably, the surface compressive stress is from 900 to 1100 MPa, the thickness of the surface compressive stress layer is from 25 to 30 μm, the internal tensile stress is from 30 to 40 MPa, and the sheet thickness is from 0.7 to 1.1 mm.

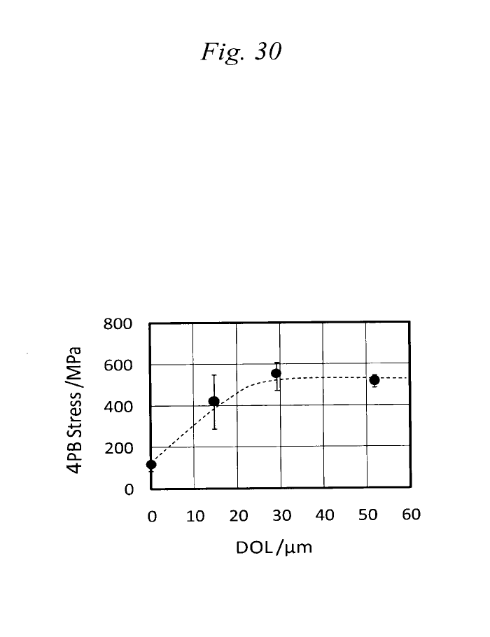

For reducing the damage to a glass sheet, heretofore it has been considered that the value of DOL is preferably increased. However, when the value of DOL is increased especially for reducing the damage to (A) and (B), the damage degree could no more be remarkably reduced even though the value of DOL is increased more than a specific level, as shown in FIG. 30. FIG. 30 is a graph showing the relationship between the thickness of the surface compressive stress layer DOL and the bending strength in a four-point bending test (JIS R1601) carried out at room temperature. As the sample, used was one having a size of 50 mm×50 mm×1.0 mm, of which the edges had been CNC-polished. The distance between the two supporting point was 40 mm, and the distance between the two load points was 10 mm. The bending strength was the average value of the data of 10 test pieces. In the four-point bending test, used was Shimadzu's Autograph AGS-X.

Accordingly, for reducing the damage to (A) and (B) and for decreasing the value of T so as to reduce the damage to (D), DOL of the glass sheet of one embodiment of the present invention is 35 μm or less. When the value is less than 20 μm, then the value of T could be decreased more; however, in the case, the bending strength is lowered as in FIG. 30, and therefore for reducing the damage to (A) and (B), the value is 20 μm or more.

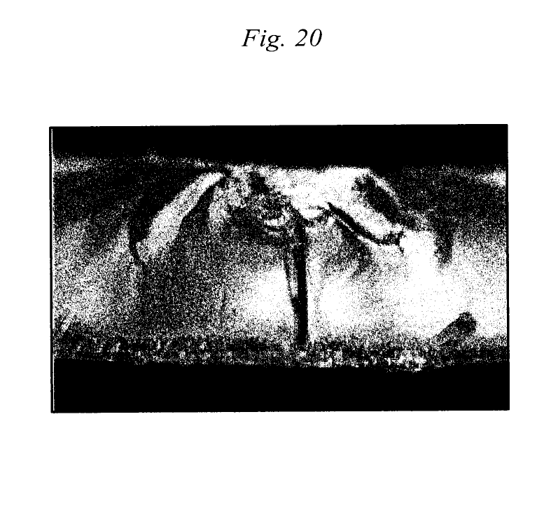

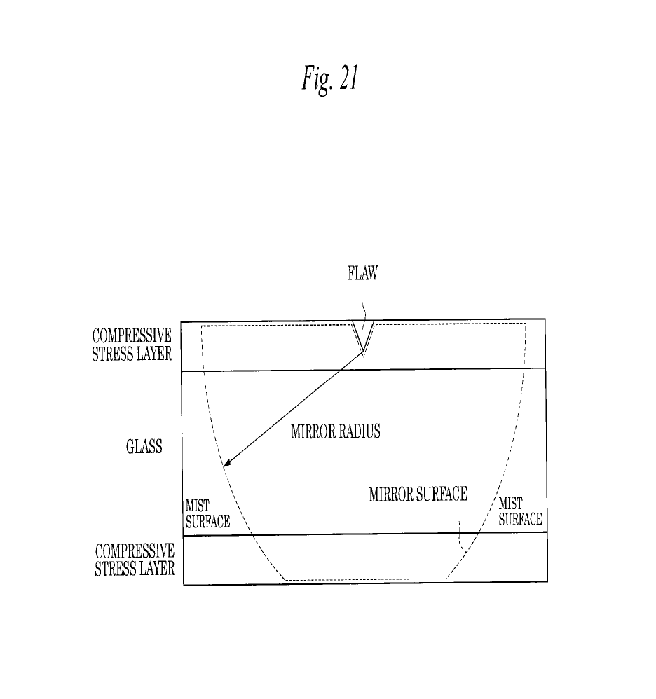

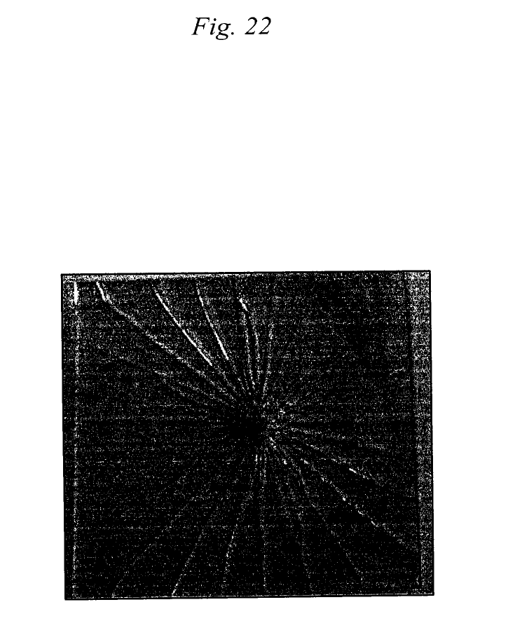

The non-slow cracking shown in FIGS. 20 to 22 indicates the damage that has been forcedly generated for comparison to slow cracking, and is not the damage mode that is grouped into the above-mentioned four types. In the non-slow cracking, the fracture origination is generated inside the surface compressive stress layer, and therefore, for preventing this, it is effective to increase the surface compressive stress S, like in the case of the damage to (A), (B) and (C) mentioned above.

These glass sheets are described in more detail with reference to the drawings.

### First Embodiment

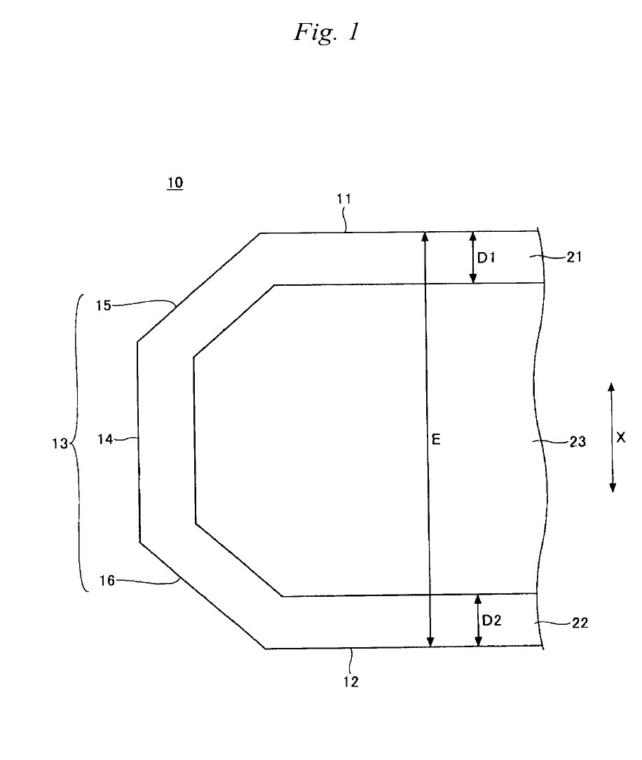

FIG. 1 to FIG. 3 are views illustrating a glass sheet of the first embodiment of the present invention.

The glass sheet 10 has front and back main surfaces 11 and 12, and an edge surface 13 adjacent to the two main surfaces 11 and 12. The two main surfaces 11 and 12 are flat surfaces parallel to each other.

The edge surface 13 is composed of a flat part 14 perpendicular to the two main surfaces 11 and 12, and chamfered parts 15 and 16 formed between each main surface 11 or 12 and the flat part 14. The flat part 14 may be the cut surface itself just formed by cutting a sheet glass having a larger area than that of the glass sheet 10, or may be a processed surface formed by processing the cut surface.

The chamfered parts 15 and 16 may be provided by four, for example, corresponding to the four sides of the rectangular main surfaces 11 and 12, or may be provided by one alone, and the number of the chamfered parts is not specifically defined. For favorably reducing the damage to (A) and (B), it is desirable that the chamfered part is provided on every side.

The chamfered parts 15 and 16 are formed by removing the corner between the cut surface or the processed surface and the main surface. The chamfered parts 15 and 16 are, for example, flat surfaces oblique to the main surfaces 11 and 12. In FIG. 1, the chamfered parts 15 and 16 have the same dimensional shape, but each may have a different dimensional shape.

The chamfered parts 15 and 16 in this embodiment are flat surfaces oblique to the main surfaces 11 and 12, but may be any other surfaces that gradually protrude from the main surfaces 11 and 12 toward the flat part 14 in the sheet thickness direction view (in the X-direction view), or may be curved surfaces. In this case, the flat surface 14 may be lost and the chamfered parts 15 and 16 may bond directly to each other, and the chamfered parts 15 and 16 may have an approximately-same radius of curvature.

The glass sheet 10 has chemically strengthened layers (compressive stress layers) 21 and 22 formed in the two main surfaces 11 and 12 to a prescribed depth from each of the main surfaces 11 and 12. The chemically strengthened layers (compressive stress layers) 21 and 22 are formed continuously to the edge surface 13 including the flat part 14 and the chamfered parts 15 and 16. The compressive stress layers are formed by dipping glass in a processing liquid for ion exchange. The ions having a small ionic radius contained in the glass surface (for example, Li ions, Na ions) are substituted with ions having a large ionic radius (for example, K ions), and therefore the compressive stress layer is formed in the glass surface to a prescribed depth from the surface. For stress balance, an internal tensile stress layer 23 is formed inside the glass.

The two compressive stress layers 21 and 22 in this embodiment have the same surface compressive stress and the same thickness, but may have a different surface compressive stress and a different thickness.

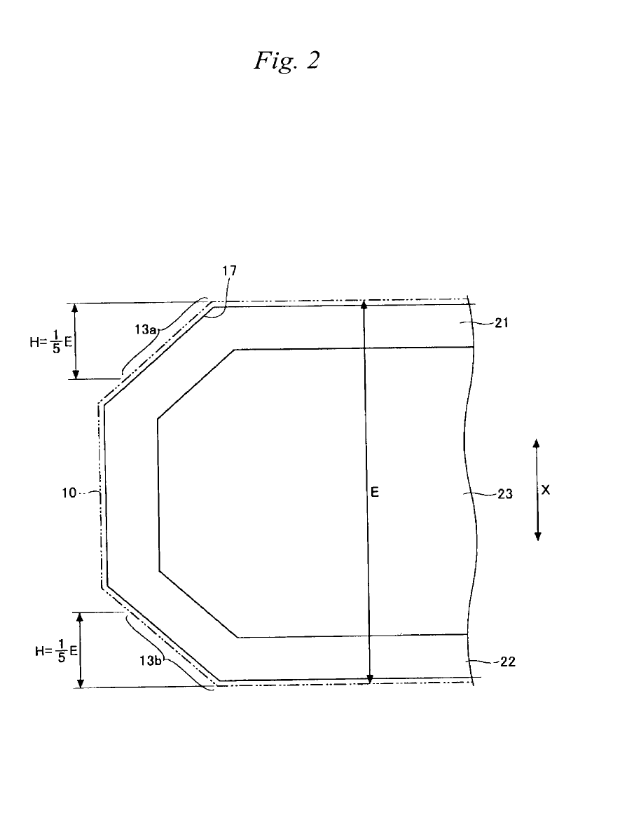

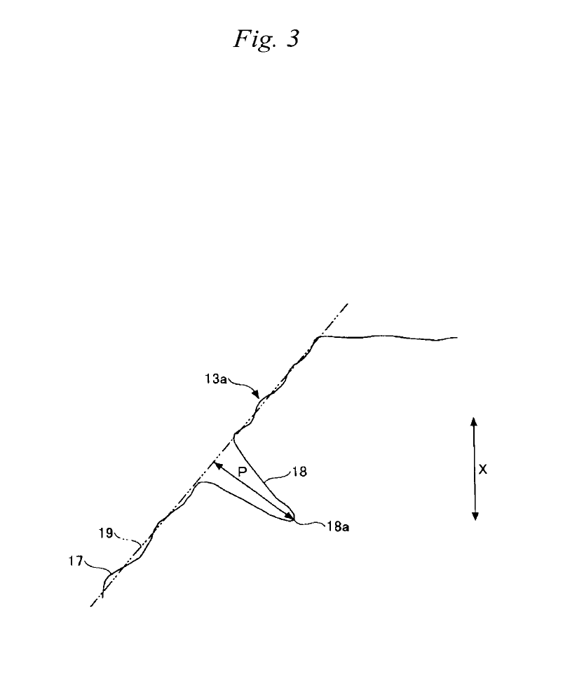

FIG. 2 is a schematic view showing a condition after etching of the glass sheet of the first embodiment of the present invention. In FIG. 2, the etched condition of the glass sheet 10 is shown by the solid line, and the condition of the glass sheet 10 before etching is shown by the two-dot chain line. FIG. 3 is a partly-enlarged view of FIG. 2, showing the relationship between an etched surface 17, a pit 18 formed in the etched surface 17, and an ideal surface 19 of the etched surface 17.

In this embodiment, when prescribed parts 13a and 13b of the edge surface 13 are etched, the etched surface 17 does not have a pit 18 having a depth of 10 μm or more (preferably a depth of 8 μm or more, more preferably a depth of 6 μm or more). The prescribed parts 13a and 13b are the parts of the edge surface 13, of which the distance H from the main surfaces 11 and 12 adjacent to the chamfered parts 15 and 16 toward the thickness direction is not more than ⅕ of the sheet thickness E (H≦⅕×E).

For the “etching”, the whole extent of the glass sheet 10 is dipped in an etching liquid at room temperature (25° C.). As the etching liquid, used here is an aqueous solution containing 5% by mass of hydrofluoric acid (HF) and 95% by mass of pure water. The etching solution penetrates into the latent flaw formed on the surface or in the inside of the glass sheet 10, and expands the latent flaw to visualize it.

The “etching amount” is controlled by the dipping time. Concretely, glass having the same composition is previously etched for a prescribed period of time to calculate the etching rate, and thereafter the intended glass sheet is etched to a desired etching level by controlling the dipping time. Depending on the type of glass, the hydrofluoric acid concentration may be varied for controlling the etching rate.

The “pit depth” is determined according to the measurement method for the projected valley part depth Rvk specified in JIS B0671-2:2002.

Here, the object to be analyzed for the presence or absence of the pit 18 having a depth of 10 μm or more therein is limited to the above-mentioned parts 13a and 13b of the edge surface 13. This is because, when a small flaw exists in the parts 13a and 13b, the glass sheet 10 would be broken starting from the small flaw serving as an origination.

In this embodiment, the surface pit 18 of the etched surface 17 is measured when the above-mentioned parts 13a and 13b are etched, for example, to a depth of 10 μm. The etching is conducted for visualize the latent flaw, and the depth is not limited to 10 μm.

Irrespective of the presence or absence of etching, the latent flaw in the parts 13a and 13b was analyzed, and the latent flaw depth was measured.

Here, the “latent flaw depth” was measured according to the process mentioned below. First, the glass sheet 10 is etched, and then the main surface of the glass substrate is polished to a prescribed level, then washed and dried, and the damaged layer that has come to have a circular pit or an oval pit through the etching treatment is observed with an optical microscope. Here, the “damaged layer” means a layer of a glass substrate having flaws or cracks formed therein in a processing step of shaping, chamfering, polishing or the like. For example, the optical microscope to be used has a 20-powered objective lens, and the viewing field for observation therewith is in a size of 635 μm×480 μm. This process is repeated a few times, and at the time when a circular pit or an oval pit could no more become observed, the etching amount of the glass sheet 10 is the “latent flaw depth”.

In the glass sheet 10 of this embodiment, the chemical strengthening is preferably attained to such that the latent flaw depth could be 0.9 or less relative to DOL of the sheet. In that manner, even if any latent flaw exists in the chamfered part, the effect of the compressive stress layer can be obtained, and therefore it is preferable. In a more preferred embodiment, the latent flaw depth is 0.7 or less relative to DOL, even more preferably 0.5 or less. Here, DOL is preferably measured in the chamfered part, but DOL may also be measured in the area inside by 10 mm from the boundary region between the chamfered part and the main surface. When DOL in that region is 0.9 or less relative to the latent flaw depth in the chamfered part, then the same effect can be realized. For more detailed evaluation, the ratio of the latent flaw depth in the chamfered part to DOL in the area inside by 10 mm from the boundary region between the chamfered part and the main surface may also be 0.9 or less, at the center of each side of the four sides of the glass sheet.

In these preferred embodiments, it is good that the glass sheet having a thickness of from 0.6 to 1.5 mm has an internal tensile stress T of 47 MPa or less, preferably 45 MPa or less, more preferably 40 MPa or less, even more preferably 35 MPa or less. In the case, the lower limit of the internal tensile stress T is preferably 20 MPa, more preferably 25 MPa.

### Second Embodiment

This embodiment relates to a production method for a glass sheet having a chamfered part.

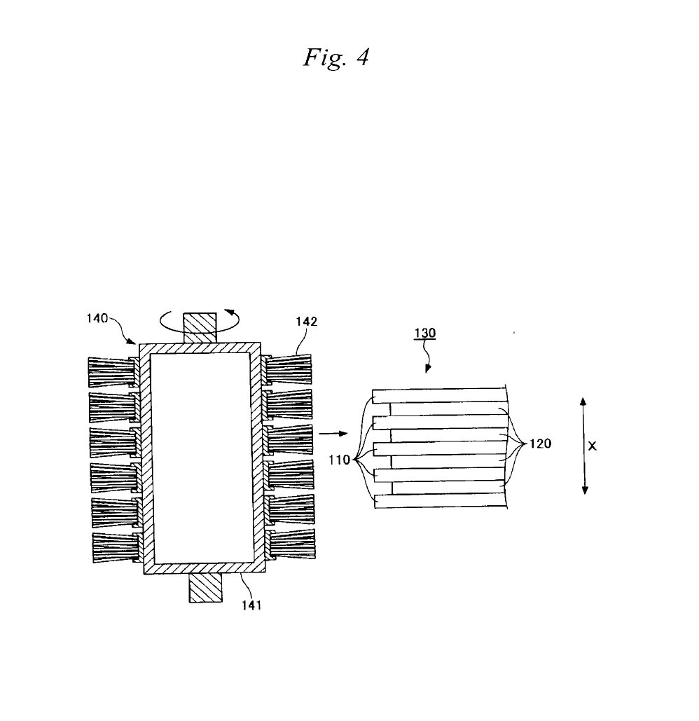

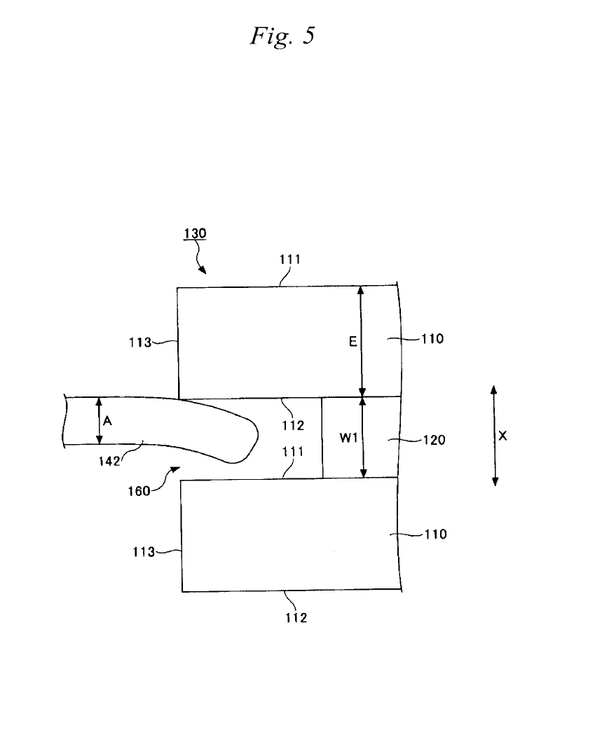

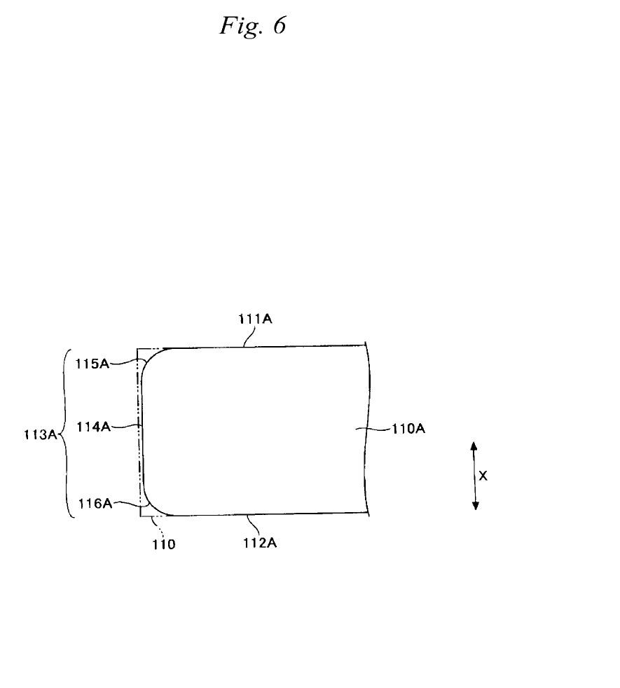

FIG. 4 to FIG. 6 are explanatory views of a production method for a glass sheet according to the second embodiment of the present invention. FIG. 4 shows a laminate 130 including glass sheets 110 that are original sheets, and a brush 140 for polishing the outer periphery of the laminate 130. FIG. 5 shows an enlarged state of the laminate 130, of which the outer periphery is polished with the brush 140. FIG. 6 shows a brush-polished glass sheet 110A by the solid line, and shows the glass sheet 110 before brush-polishing by the two-dot chain line.

The production method for the glass sheet comprises a lamination step of forming the laminate 130 by putting a spacer 120 between the glass sheets 110, and a polishing step of polishing the outer periphery of the laminate 130 with the brush 140. The production method for the glass sheet further comprises a separation step of separating the glass sheet 110A obtained by polishing the glass sheet 110 with the brush 140, from the spacer 120.

The laminate 130 comprises multiple glass sheets 110, and tabular spacers 120 arranged between the neighboring glass sheets 110, as shown in FIG. 4. The glass sheets 110 and the spacers 120 are alternately piled up, and are fixed by holding them with a jig such as a clamp or the like. Between the glass sheet 110 and the spacer 120, a protective sheet for preventing the glass sheet 110 from being damaged may be arranged. The protective sheet is formed of a resin or the like.

The glass sheets 110 and the spacers 120 are fixed by a jig in this embodiment, but the fixation method is not specifically defined. For example, the fixation method may be a method of bonding the glass sheet 110 and the spacer 120 to each other. As the adhesive, employable is one capable of being removed in the separation step after the polishing step, and for example, there may be employed a thermosoftening resin. In place of forming such an adhesive layer between the glass sheet 110 and the spacer 120, the spacer 120 itself may be used as the adhesive layer.

The respective glass sheets 110 may be prepared, for example, by chemically strengthening a sheet glass having a larger area than the glass sheet 110, and then cutting it into multiple glass sheets. The type of the sheet glass, the chemical strengthening method and the cutting method are the same as those in the first embodiment, and therefore the description thereof is omitted here.

Each glass sheet 110 has two main surfaces 111 and 112 and a side surface 113 adjacent to the two main surfaces 111 and 112, as shown in FIG. 5. The two main surfaces 111 and 112 are flat surfaces that are parallel to each other. The side surface 113 is a cut surface and is a plane surface perpendicular to the main surfaces 111 and 112.

Each glass sheet 110 has a compressive stress layer formed in the two main surfaces 111 and 112 and in the side surface 113, to a prescribed depth from each of the two main surfaces 111 and 112 and the side surface 113, like the glass sheet 10 shown in FIG. 1. For stress balance, an internal tensile stress layer is formed between the compressive stress layers.

Each glass sheet 110 has an approximately-same dimensional shape, and the sheets are laminated in such a manner that the outer peripheries thereof could overlap with each other in the lamination direction view (in the drawing, in the arrow X direction), as shown in FIG. 4. Consequently, the outer peripheries of the glass sheets 110 are evenly polished.

For each spacer 120, used is a material softer than the glass sheet, and for example, the spacer may be formed of a polypropylene resin, a foamed urethane resin or the like.

The spacers 120 have an approximately-same dimensional shape. The spacers 120 are arranged more inside than the outer peripheries of the glass sheets 110 in the lamination direction view (in the drawing, in the arrow X direction view), and form spaces 160 between the neighboring glass sheets 110.

The brush 140 is a roll brush as shown in FIG. 4, and is composed of a rotation axis 141 parallel to the lamination direction of the laminate 130, and bristles 142 held nearly perpendicular to the rotation axis 141. The brush 140 is, while rotated around the rotation axis 141 as the center, moved relatively along the outer periphery of the laminate 130, and ejects a slurry including an abrasive toward the outer periphery of the laminate 130 to thereby brush and polish the outer peripheral part of the laminate 130. As the abrasive, usable is cerium oxide, zirconia or the like. The particle size (D50) of the abrasive is, for example, 5 μm or less, preferably 2 μm or less.

The brush 140 is a channel brush, in which a long member (channel) with multiple bristles 142 planted therearound is spirally coiled around the rotation axis 141.

The bristles 142 are formed mainly of a resin such as polyamide or the like, and may contain an abrasive such as alumina (Al₂O₃), silicon carbide (SiC), diamond or the like. The bristles 142 are formed linearly, and each may have a tapered tip.

In this embodiment, the width W1 of the space 160 is 1.25 times or more the maximum diameter A of the bristle 142 (W1≧1.25×A). Consequently, the bristle 142 can be smoothly inserted into the space 160, as shown in FIG. 5, and the corner of the main surface 111 or 112 and the side surface 113 of the glass sheet 110 can be chamfered with the bristle 142 to be a curved surface.

The width W1 of the space 160 is preferably 1.33×A or more, more preferably 1.5×A or more. The width W1 of the space 160 may be smaller than the thickness E of the glass sheet 110, for improving the brushing and polishing efficiency.

The glass sheet 110A thus polished with the brush 140 has two main surfaces 111A and 112A, and a side surface 113A adjacent to the two main surfaces 111A and 112A, as shown by the solid line in FIG. 6. The two main surfaces 111A and 112A are flat surfaces parallel to each other. The side surface 113A is composed of a flat part 114A perpendicular to the main surfaces 111A and 112A, and chamfered parts 115A and 116A formed between each main surface 111A or 112A and the flat part 114A. The chamfered parts 115A and 116A are curved surfaces gradually protruding outwardly from the main surfaces 111A and 112A toward the flat part 114A in the thickness direction view (X direction view).

The flat part 114A is formed by polishing the side surface of the glass sheet 110 shown by the two-dot chain line in FIG. 6, with the soft bristles 142. The chamfered parts 115A and 116A are formed by polishing the corner of the main surface and the side surface of the glass sheet 110 shown by the two-dot chain line in FIG. 6, with the outer peripheral surfaces of the bristles 142.

The side surface 113A of the glass sheet 110A is polished with a slurry that contains an abrasive having a particle diameter of 5 μm or less, by inserting the bristles 142 into the space controlled by the spacers 120, and therefore, when a prescribed part of the side surface 113A is etched to a depth of 10 then there exists no pit having a depth of 1 μm or more in the etched surface. The prescribed part is a part of the side surface 113A, of which the distance from the main surfaces 111A and 112A adjacent to the chamfered parts 115A and 116A toward the thickness direction is ⅕ or less of the sheet thickness. Accordingly, the glass sheet 110A excellent in bending strength can be obtained here, like in the first embodiment.

### Third Embodiment

This embodiment relates to a production method for a glass sheet having a chamfered part. This embodiment further includes a step of grinding the outer peripheral part of a glass sheet prior to forming a laminate.

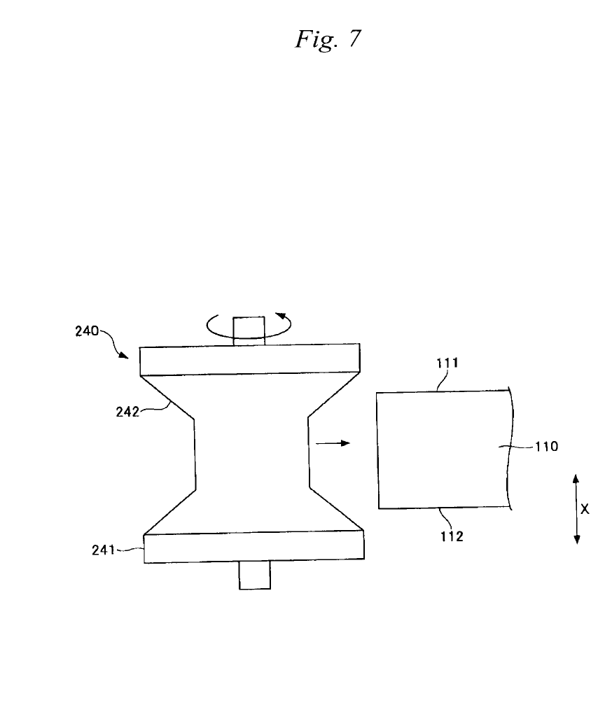

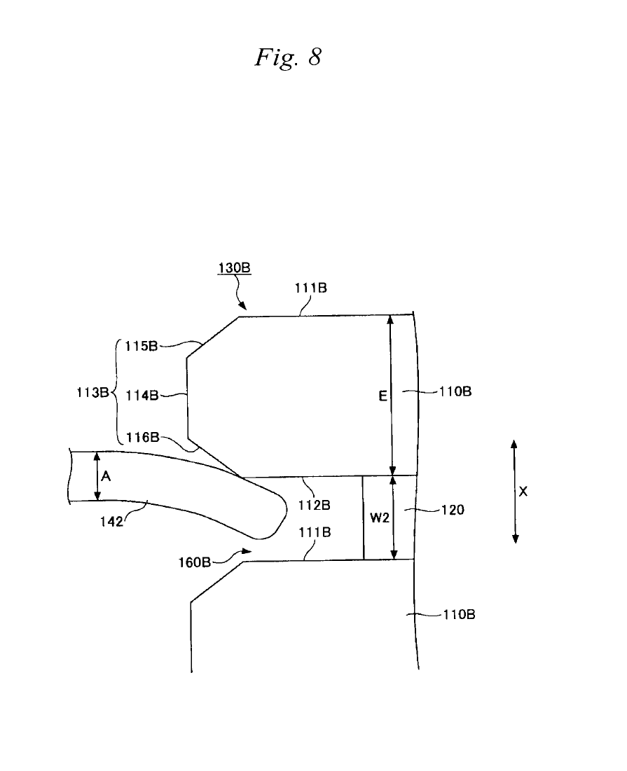

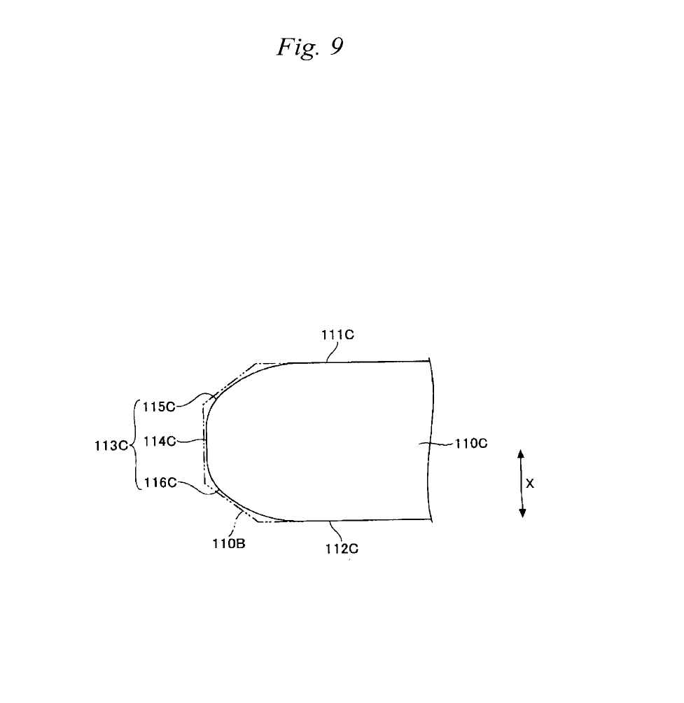

FIG. 7 to FIG. 9 are explanatory views of a production method for a glass sheet according to the third embodiment of the present invention. FIG. 7 shows a rotary grinding stone 240 for grinding a glass sheet 110 that is an original sheet and the outer peripheral part of the glass sheet 110. FIG. 8 shows an enlarged view of polishing the outer peripheral part of a laminate 130B including the glass sheets 110B having been ground with the rotary grinding stone 240, using the brush 140 (see FIG. 4). FIG. 9 shows a brush-polished glass sheet 110C by the solid line, and shows the glass sheet 110B before brush-polishing by the two-dot chain line.

The production method for the glass sheet comprises a grinding step of grinding the outer peripheral part of the glass sheet 110 with the disk-like rotary grinding stone 240, a lamination step of forming the laminate 130B by putting a spacer 120 between the glass sheets 110B prepared by grinding the glass sheets 110, and a polishing step of polishing the outer periphery of the laminate 130B with the brush 140. The production method for the glass sheet further comprises a separation step of separating the glass sheet 110C obtained by polishing the glass sheet 110B with the brush 140, from the spacer 120.

In the outer peripheral surface 241 of the rotary grinding stone 240, formed is a circular grinding groove 242 that extends in the circumferential direction. The wall surface of the grinding groove 242 contains abrasive grains of alumina, silicon carbide, diamond or the like. The particle size of the abrasive grains (JIS R6001) is, for example, from #300 to #2000. The particle size is measured according to JIS R6002. Having a smaller particle size, abrasive grains have a larger particle diameter and therefore realize a good grinding efficiency.

The rotary grinding stone 240 is, while rotated around the center line of the rotary grinding stone 240, moved relatively along with the outer periphery of the glass sheet 110, and thus grinds the outer peripheral part of the glass sheet 110 with the wall surface of the grinding groove 242. During grinding, a coolant liquid such as water or the like may be used.

The glass sheet 110B ground with the rotary grinding stone 240 has two main surfaces 111B and 112B and a side surface 113B adjacent to the two main surfaces 111B and 112B, as shown in FIG. 8. The side surface 113B is the ground surface that was ground with the rotary grinding stone 240, and is composed of a flat part 114B perpendicular to the main surfaces 111B and 112B, and chamfered parts 115B and 116B formed between each main surface 111B or 112B and the flat part 114B. The chamfered parts 115B and 116B are, for example, flat surfaces oblique to the main surfaces 111B and 112B.

The chamfered parts 115B and 116B in this embodiment are flat surfaces oblique to the main surfaces 111B and 112B, but may be any other surfaces that gradually protrude from the main surfaces 111B and 112B toward the flat part 114B in the sheet thickness direction view (in the X-direction view), or may be curved surfaces. In this case, the flat surface 114B may be lost and the chamfered parts 115B and 116B may bond directly to each other, and the chamfered parts 115B and 116B may have an approximately-same radius of curvature.

The laminate 130B comprises multiple glass sheets 110B ground with the rotary grinding stone 240, and tabular spacers 120 arranged between the neighboring glass sheets 110B. The glass sheets 110B and the spacers 120 are alternately piled up, and are fixed by holding them with a jig such as a clamp or the like. Between the glass sheet 110B and the spacer 120, a protective sheet for preventing the glass sheet 110B from being damaged may be arranged. The protective sheet is formed of a resin or the like. As the method of fixing the glass sheets 110B and the spacers 120, also employable here is any other fixation method like in the second embodiment.

Each glass sheet 110B ground with the rotary grinding stone 240 has an approximately-same dimensional shape, and the sheets are laminated in such a manner that the outer peripheries thereof could overlap with each other in the lamination direction view (in the drawing, in the arrow X direction). Consequently, the outer peripheries of the glass sheets 110B are evenly polished. During polishing, a coolant liquid such as water or the like may be used.

The spacers 120 have an approximately-same dimensional shape, and each is arranged more inside than the ground surface (the flat part 114B and the chamfered parts 115B and 116B) of the glass sheet 110B in the lamination direction view (in the drawing, in the arrow X direction view), therefore the spacers form spaces 160B between the neighboring glass sheets 110B.

In this embodiment, the width W2 of the space 160B is 1.25 times or more the maximum diameter A of the bristle 142 (W2≧1.25×A), like in the second embodiment. Consequently, the bristle 142 can be smoothly inserted into the space 160B, as shown in FIG. 8, and the boundary part between the main surface 111B or 112B and the chamfered part 115B or 116B of the glass sheet 110B can be chamfered with the bristle 142 to be a curved surface. At this time, the boundary part between the chamfered part 115B or 116B and the flat part 114B can be also chamfered with the bristle 142.

The width W2 of the space 160B is preferably 1.33×A or more, more preferably 1.5×A or more. The width W2 of the space 160B may be smaller than the thickness E of the glass sheet 110B, for improving the brushing and polishing efficiency.

The glass sheet 110C thus polished with the brush 140 (see FIG. 4) has two main surfaces 111C and 112C, and a side surface 113C adjacent to the two main surfaces 111C and 112C, as shown by the solid line in FIG. 9. The two main surfaces 111C and 112C are flat surfaces parallel to each other. The side surface 113C is composed of a flat part 114C perpendicular to the main surfaces 111C and 112C, and chamfered parts 115C and 116C formed between each main surface 111C or 112C and the flat part 114C. The chamfered parts 115C and 116C are surfaces gradually protruding outwardly from the main surfaces 111C and 112C toward the flat part 114C in the thickness direction view (X direction view).

The side surface 113C of the glass sheet 110C is polished with a slurry that contains an abrasive having a particle diameter of 5 μm or less, by inserting the bristles into the space controlled by the spacers 120, and therefore, when a prescribed part of the side surface 113C is etched, then there exists no pit having a depth of 10 μm or more in the etched surface. The prescribed part is a part of the side surface 113C, of which the distance from the main surfaces 111C and 112C adjacent to the chamfered parts 115C and 116C toward the thickness direction is ⅕ or less of the sheet thickness. Accordingly, the glass sheet 110C excellent in bending strength can be obtained here, like in the first embodiment.

### Fourth Embodiment

This embodiment relates to a production method for a glass sheet having a chamfered part. This embodiment includes a step of polishing the glass sheet with a sheet having abrasive grains, in place of the step of polishing the glass sheet with a brush.

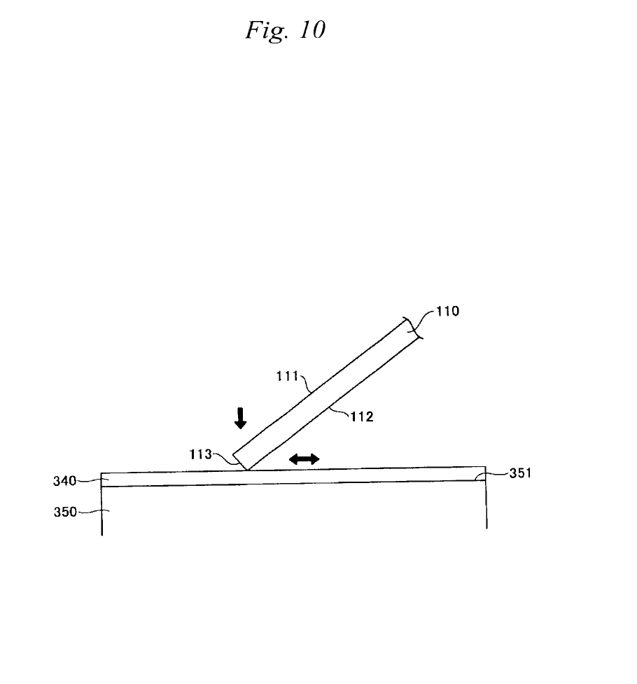

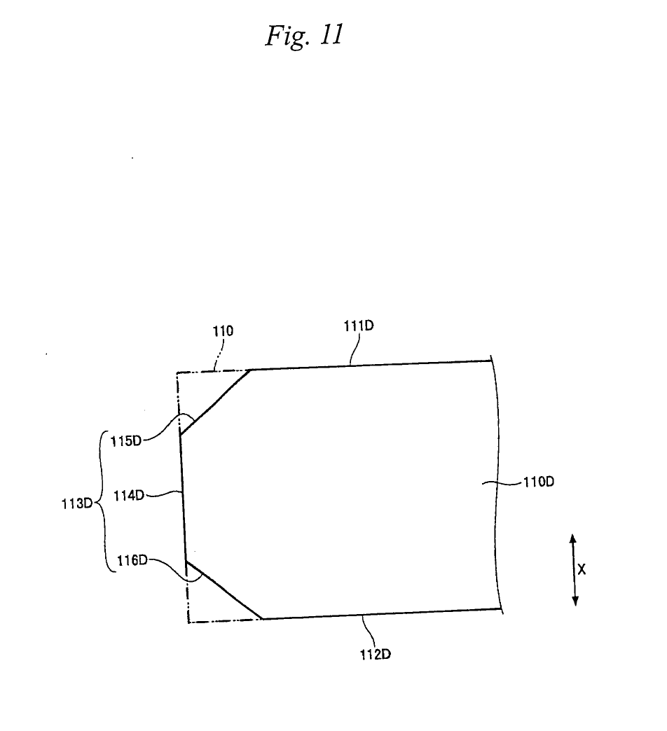

FIG. 10 to FIG. 11 are explanatory views of a production method for a glass sheet according to the fourth embodiment of the present invention. FIG. 10 shows a glass sheet 110 that is an original sheet and a sheet 340 for polishing the glass sheet 110. FIG. 11 shows a glass sheet 110D after sheet polishing by the solid line, and shows the glass sheet 110 before sheet polishing by the two-dot chain line.

The production method for the glass sheet comprises a polishing step of polishing the outer peripheral part of the glass sheet 110 with the sheet 340 containing abrasive grains. As the sheet 340, usable here is one prepared by uniformly bonding abrasive grains on a sheet substrate of resin, paper or the like, or one prepared by burying abrasive grains in a resin-made sheet substrate in such a manner that a part of the abrasive grains are exposed out.

The sheet 340 is fixed on the fixation surface 351 of the base 350, and has a shape that follows the fixation surface 351. The fixation surface 351 may be a flat surface as shown in FIG. 10, or may be a curved surface.

The sheet 340 contains abrasive grains on the side opposite to the side of the fixation surface 351. While pressed against the abrasive grains-containing side, the glass sheet 110 is slid thereon, and the glass sheet 110 is thus polished. In polishing, a lubricant liquid such as water or the like may be used.

In this embodiment, the sheet 340 is fixed on the base 350, and the glass sheet 110 is slid thereon while pressed against the abrasive grains-containing side of the sheet 340. As the case may be, the abrasive grains-containing side of the sheet 340 kept given a tension applied thereto may be pressed against the glass sheet 110 that is slid on the sheet 340.

As the abrasive grains for the sheet 340, employable here is a powder of alumina, silicon carbide or diamond. Concretely, abrasive grains having a particle size of #6000 or more (JIS R6001) may be used. Having a larger particle size, abrasive grains have a smaller particle diameter. The particle size of the abrasive grains is measured according to JIS R6002. The particle size of the abrasive grains is preferably #8000 or more, more preferably #10000 or more.

The polished glass sheet 110D has two main surfaces 111D and 112D, and a side surface 113D adjacent to the two main surfaces 111D and 112D, as shown by the solid line in FIG. 11. The two main surfaces 111D and 112D are flat surfaces parallel to each other. The side surface 113D is composed of a flat part 114D perpendicular to the main surfaces 111D and 112D, and chamfered parts 115D and 116D formed between each main surface 111D or 112D and the flat part 114D. The chamfered parts 115D and 116D are surfaces gradually protruding outwardly from the main surfaces 111D and 112D toward the flat part 114D in the thickness direction view (X direction view), and a flat surfaces oblique to the main surfaces 111D and 112D.

The flat part 114D has no latent flaw, as it is just a cut surface. The flat part 114D may be one formed by polishing with the sheet 340.

The chamfered parts 115D and 116D are polished with the sheet 340 that contains abrasive grains having a larger particle size (or having a smaller particle diameter) than usual.

The side surface 113D of the glass sheet 110D is polished with the sheet 340 that contains abrasive grains having a larger particle size (or having a smaller particle diameter) than usual, and therefore when a prescribed part of the side surface 113D is etched, the etched surface does not have a pit having a depth of 10 μm or more. The prescribed part is a part of the side surface 113D, of which the distance from the main surfaces 111D and 112D adjacent to the chamfered parts 115D and 116D toward the thickness direction is ⅕ or less of the sheet thickness. Accordingly, the glass sheet 110D excellent in bending strength can be obtained here, like in the first embodiment.

### Fifth Embodiment

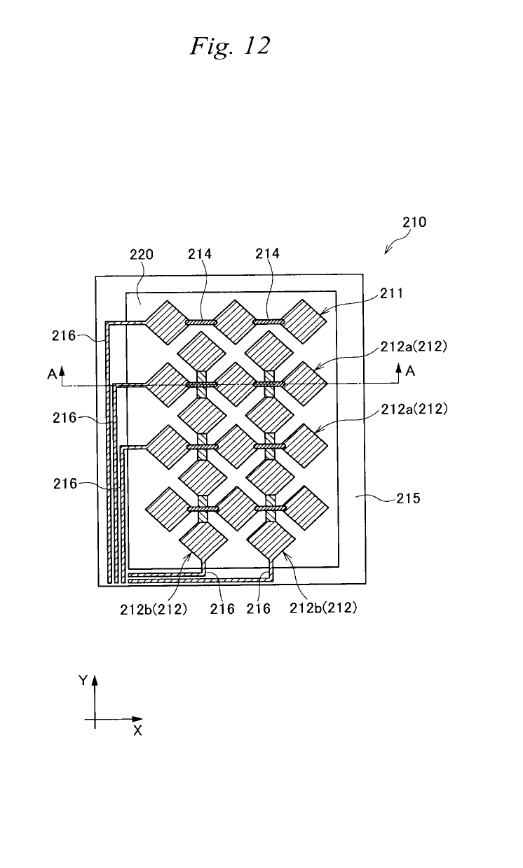

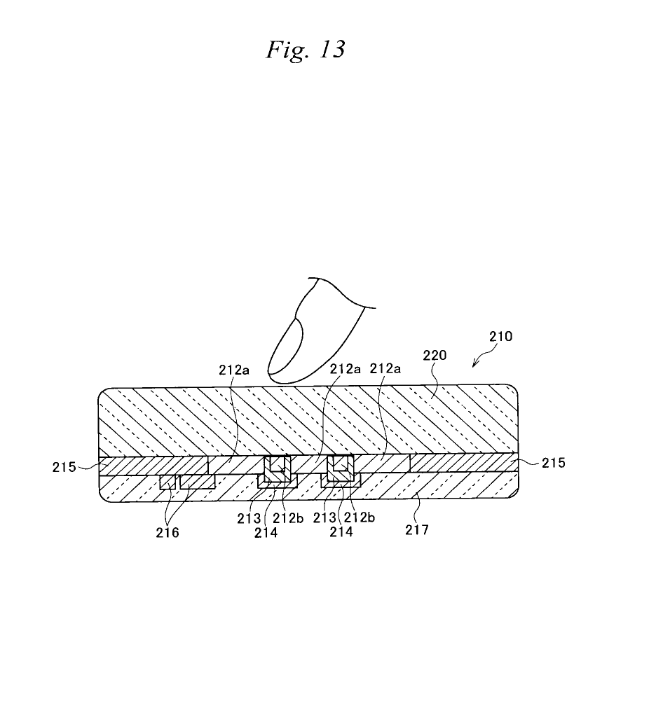

This embodiment relates to a touch sensor-attached chemically strengthened glass. FIG. 12 is a plan view to constitute the main part of a touch sensor-attached chemically strengthened glass according to one embodiment of the present invention, and FIG. 13 is an A-A line cut cross-sectional view of FIG. 12.

The touch sensor-attached chemically strengthened glass 210 comprises a touch sensor 211 and a chemically strengthened glass 220 for mounting the touch sensor 211 thereon, and this is a touch sensor-attached chemically strengthened glass that is used in 2-in-1 type display devices. Specifically, the chemically strengthened glass 220 of the touch sensor-attached chemically strengthened glass 210 has both the function as a cover glass and the function as a sensor substrate.

The touch sensor 211 is so configured in the surface of one side of the chemically strengthened glass 220, that column electrodes extending in the axial direction of the two crossing axes of X-axis and Y-axis are formed in an electrically non-contact state via an electric insulating layer arranged therebetween at the intersections of those column electrodes. Here, the column electrode extending in the X-axis direction is referred to as a first electrode 212a, and the column electrode extending in the Y-axis direction is referred to as a second electrode 212b. For detecting the site of touch, the first electrode 212a and the second electrode 212b each extending in each direction must be independent of each other. For this reason, in this embodiment, a column electrode pattern of the first electrode 212a and the second electrode 212b to constitute a matrix configuration (an electrode pattern of multiple columns extending in each direction) is arrayed on the surface of one side of the chemically strengthened glass 220 as a transparent electrode pattern 212 of one layer, and in the region where two columns intersect with each other, the divided sites of the transparent electrode pattern 212 as divided so that any one column could not be kept in contact with the other column are connected to each other via a bridge wire 214. In the region where the bridge wire 214 overlaps with the transparent electrode pattern 212 (intersection region), there is provided an insulating layer 213 formed of an insulating substance between the transparent electrode pattern 212 and the bridge wire 214.

The reference number 215 is a light-shielding black layer that is formed in the peripheral part of the chemically strengthened glass 220 to surround the transparent electrode pattern 212, and the reference number 216 indicates a steering wire to the electrode assembly to constitute each electrode column. The steering wire 216 may be connected to any one of the electrode pattern of the respective columns. As the lowermost layer of the touch sensor 211, a protective glass 217 is formed.

As the transparent, electrically-insulating substance to constitute the insulating layer 213, usable here is an organic resin material. When an organic resin material is used for forming the insulating layer, a patterned resin-made insulating layer may be formed with ease through photolithography.

As the conductive substance to constitute the bridge wire 214, preferred is use of a metal material capable of readily realizing a high adhesion force to the chemically strengthened glass 220. In particular, when the transparent substrate is a glass substrate, preferred is use of a metal material having a high adhesion force to the glass substrate, having a higher electroconductivity than ITO and excellent in durability and abrasion resistance, such as Mo, Mo alloy, Al, Al alloy, Au, Au alloy, etc.

The chemically strengthened glass 220 on which the touch sensor 211 is mounted has a thickness of 1.5 mm or less, more preferably 1.0 mm or less, even more preferably 0.8 mm or less.

The chemical strengthening for obtaining the chemically strengthened glass 220 may be carried out by dipping a glass in a molten salt of potassium nitrate (KNO₃) at 380° C. to 450° C. for 0.1 to 20 hours. By varying the temperature of the molten salt of potassium nitrate (KNO₃), the dipping time and the molten salt to be used, the level of chemical strengthening can be controlled. As a result of the chemical strengthening, a compressive stress layer is formed in the glass surface and an internal tensile stress layer is formed inside the glass.

The chemically strengthened glass 220 in the present invention must be resistant to all the above-mentioned four damage modes, and for this, the glass is so chemically strengthened that the surface compressive stress S of the compressive stress layer thereof could be 800 MPa or more and the internal tensile stress T thereof could be from 8 MPa to 40 MPa. The reason is described below.

In the chemically strengthened glass 220 that has been chemically strengthened in the manner as above, the depth of the compressive stress layer is preferably 15 μm or more, more preferably 20 μm or more, even more preferably 25 μm or more. This is because, by controlling the depth of the compressive stress layer to be larger than the depth of the latent flaw that may be formed in edge surface treatment such as cutting, chamfering or the like, the desired edge surface strength can be realized.

### Sixth Embodiment

This embodiment relates to a production method for a touch sensor-attached chemically strengthened glass.

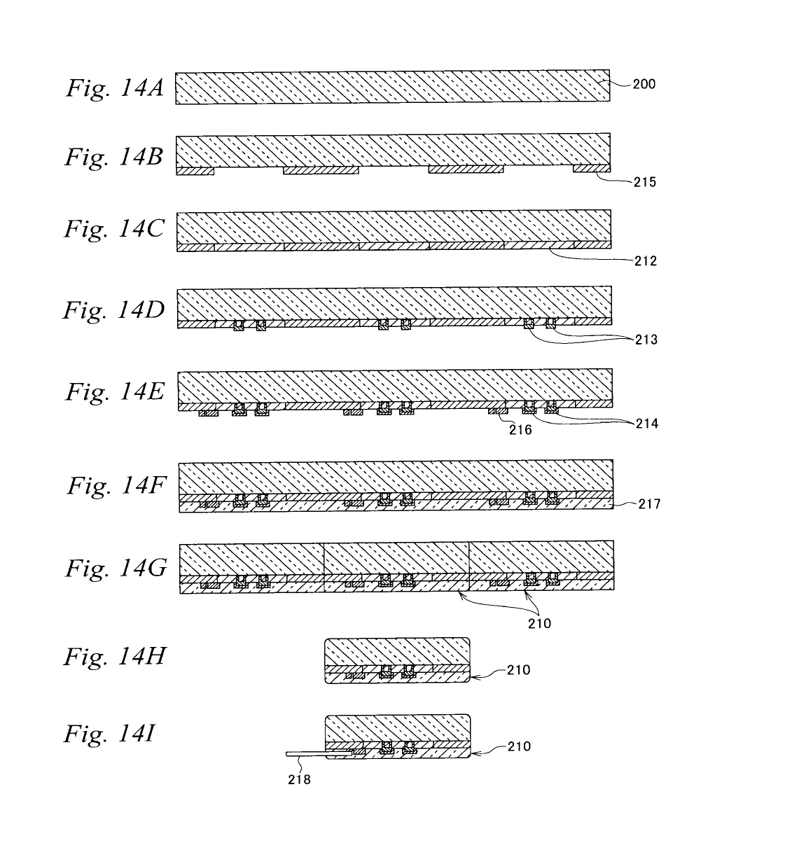

FIGS. 14A to 14I are views of explaining a production method for a touch sensor-attached chemically strengthened glass.

First a large-size chemically-strengthened glass 200 capable of dividing into multiple chemically strengthened glass sheets for display devices is prepared (FIG. 14A). On one side of the chemically strengthened glass 200, a black layer 215 is formed at the position corresponding to the peripheral part of each chemically strengthened glass sheet (FIG. 14B). The chemically strengthened glass 200 is one prepared through chemical strengthening so as to have a surface compressive stress S of 800 MPa or more, and an internal tensile stress of from 8 MPa to 40 MPa, as described above.

Subsequently, on one side of the chemically strengthened glass 200, a transparent electrode pattern 212 is formed (FIG. 14C). For example, an ITO film is formed on one side of the chemically strengthened glass 200 according to a sputtering method or the like, and the formed ITO film is patterned as in FIG. 12 thereby to form a transparent electrode pattern 212 of a prescribed pattern configuration. In forming the transparent electrode pattern 212, employable here is a photolithographic processing method (hereinafter referred to as photolithography) where an ITO film is formed by coating, then photoexposed via a mask having a prescribed pattern, and then etched.

At this time, on the same side of the chemically strengthened glass 200 on which the transparent electrode pattern 212 is formed (that is, on the side having the transparent electrode pattern 212 formed thereon), an insulating layer 213 that covers a specific site of the transparent electrode pattern 212 (the region where the column electrode pattern of the first electrode 212a in the X-axis direction and the column electrode pattern of the second electrode 212b in the Y-axis direction intersect with each other, or that is, in the intersection region of the column electrode pattern) is formed, for example, according to photolithography (FIG. 14D).

Next, bridge wires 214 are formed, each connecting the specific sites of the transparent electrode pattern 212 (divided parts of the first electrode 212a) to stride over the insulating layer 213 provided in each intersection region (FIG. 14E). For example, on the same surface of the chemically strengthened glass 200 with the insulating layer 213 formed thereon (on the surface on which the insulating layer 213 is formed), a metal film is formed using a metallic conductive substance according to a sputtering method or the like, and the metal film is patterned through photolithography to form a patterned bridge wire 214. At this time, the metal film is formed to cover also the steering wire part, and the metal film is patterned to form the steering wire 216 at the same time as in the patterning step of forming the bridge wire through photolithography. Accordingly, the state shown in FIG. 12 is completed.

Subsequently, SiO₂ is sputtered to form the protective glass 217 (FIG. 14F), and this is divided into touch sensor-attached chemically strengthened glass 210 (FIG. 14G), and the touch sensor-attached chemically strengthened glass 210 is chamfered at the corners thereof (FIG. 14H). Finally, a flexible wire substrate 218 is connected by pressing to the touch sensor-attached chemically strengthened glass 210 to produce the touch sensor-attached chemically strengthened glass 210 (FIG. 14I).

As in the above, the touch sensor-attached chemically strengthened glass 210 can be produced according to photolithography in forming the touch sensor 211. Consequently, the chemically strengthened glass 220 preferably has resistance to acid. Concretely, it is desirable that the weight reduction of the chemically strengthened glass, when dipped in 0.1 mol % hydrochloric acid at a temperature of 90° C. for 20 hours, is 1 mg/cm² or less. Using the chemically strengthened glass having such high resistance to acid, a touch sensor can be mounted on the chemically strengthened glass through photolithography.

Here, chemically strengthened glasses were prepared by cutting glass A5 to E5 of the above-mentioned five types of glass materials A to E into a size of 50 mm×50 mm, and polishing them. Each chemically strengthened glass was dipped in 0.1 mol % hydrochloric acid at a temperature of 90° C. for 20 hours, and the weight reduction (mg/cm²) thereof per the glass unit area was measured.

Glass A5 to E5 each have the properties as shown in Table 5. Table 5 shows the weight reduction (mg/cm²) of each glass.

TABLE 5

| Type of Glass | Glass A5 | Glass B5 | Glass C5 | Glass D5 | Glass E5 |
|---|---|---|---|---|---|
| Glass Material | A | B | C | D | E |
| Thickness of | 1.0 | 1.0 | 1.0 | 1.0 | 1.0 |
| Glass | | | | | |
| (mm) | | | | | |
| S | 701 | 1219 | 1065 | 753 | 733 |
| (MPa) | | | | | |
| DOL | 44.4 | 47.3 | 49 | 48.9 | 49.1 |
| (μm) | | | | | |
| Weight Reduction | 0.003 | 12 | 0.015 | 0.030 | 0.16 |
| (mg/cm²) | | | | | |

The results confirm that the glass A, C and D all have excellent resistance to acid as the weight reduction per the glass unit area thereof is less than 1 mg/cm².

The first to sixth embodiments of the present invention have been described in the above, but the present invention is not limited to the above-mentioned embodiments. Not overstepping the scope of the present invention, various modifications and substitutions can be added to the above-mentioned embodiments.

For example, a grinding groove is formed in the outer peripheral surface of the rotary grinding stone in the third embodiment; however, the groove may not be formed. When the grinding groove is not formed, the side surface of the glass sheet ground with the outer peripheral surface of the rotary grinding stone is to be a surface perpendicular to the main surface. Consequently, in the absence of the grinding groove, a glass sheet having an approximately-same shape as that of the glass sheet 110 that is the original glass shown by the two-dot chain line in FIG. 6 can be obtained by grinding, and in the subsequent brush polishing, a glass sheet having an approximately-same shape as that of the glass sheet 110A shown by the solid line in FIG. 6 can be obtained.

In the third embodiment, the corners of the glass sheet may be polished with a sheet, in place of being ground with the rotary grinding stone having a grinding groove. The sheet polishing provides a glass sheet having an approximately-same shape as that of the glass sheet 110B shown by the two-dot chain line in FIG. 9, and through the subsequent brush polishing, there can be obtained a glass sheet having an approximately-same shape as that of the glass sheet 110C shown by the solid line in FIG. 9. In this case, the particle size of the abrasive grains contained in the sheet may be #1000 or more, differing from that in the fourth embodiment.

Also in the third embodiment, the corners of the ground glass sheet may be polished with a sheet after ground with a rotary grinding stone having no grinding groove, in place of being ground with the rotary grinding stone having a grinding groove. The sheet polishing provides a glass sheet having an approximately-same shape as that of the glass sheet 110B shown by the two-dot chain line in FIG. 9, and through the subsequent brush polishing, there can be obtained a glass sheet having an approximately-same shape as that of the glass sheet 110C shown by the solid line in FIG. 9. In this case, the particle size of the abrasive grains contained in the sheet may be #1000 or more, differing from that in the fourth embodiment.

The chemically strengthening method for obtaining the strengthened glass sheet of the present invention is not specifically defined so far as the method enables ion exchange between Na in the glass surface layer and K in the molten salt. For example, there may be mentioned a method of dipping glass in a heated molten salt of potassium nitrate. In the present invention, the molten salt of potassium nitrate or a salt of potassium nitrate is not limited to KNO₃ alone, but includes those containing, along with KNO₃ therein, NaNO₃ in an amount of 10% by mass or less, etc.

The chemical strengthening treatment condition for forming a chemically strengthened layer (compressive stress layer) having a desired surface compressive stress in glass may vary depending on the sheet thickness. Typically, a glass substrate may be dipped in a molten salt of potassium nitrate at 350 to 550° C. for 2 to 20 hours. From an economical point of view, a glass substrate is dipped preferably at 350 to 500° C. for 2 to 16 hours, more preferably for 2 to 10 hours.

The glass sheet of the present invention has an approximately rectangular shape; however, in the front view thereof, the corners of the sheet may be rounded, or the sides thereof may be protruded or recessed outwardly or inwardly relative to the surface direction of the sheet.

The production method for the glass sheet in the present invention is not specifically limited. For example, various starting materials are formulated each in a suitable amount, heated and melted at about 1400 to 1800° C., then defoamed and homogenized by stirring, and are thereafter shaped into sheets according to a well-known float process, a down-drawing process, a pressing process or the like. After gradually cooled, the sheets are cut into a desired size.

Preferably, the glass transition point Tg of the glass for the glass sheet of the present invention is 400° C. or higher. When the glass transition point is lower than 400° C., then the surface compressive stress would be relaxed during ion exchange and therefore the resultant sheets could not be given a sufficient stress. More preferably, the glass transition point is 550° C. or higher.

Preferably, the temperature T2 at which the viscosity of the glass for the glass sheet of the present invention could be 10² dPa·s is 1800° C. or lower, more preferably 1750° C. or lower.

Preferably, the temperature T4 at which the viscosity of the glass in the present invention could be 10⁴ dPa·s is 1350° C. or lower.

Preferably, the specific gravity ρ of the glass for the glass sheet of the present invention is from 2.37 to 2.55.

Preferably, the Young's modulus E of the glass for the glass sheet of the present invention is 65 GPa or more. When the Young's modulus is less than 65 GPa, the rigidity and the strength at fracture of the glass for cover glass would be insufficient.

Preferably, the Poisson ratio σ of the glass for the glass sheet of the present invention is 0.25 or less. When the ratio is more than 0.25, then the cracking resistance of the glass would be insufficient.

Next described is the glass composition for the glass sheet of the present invention. Unless otherwise specifically indicated, the composition is expressed in terms of molar percentage content.

SiO₂ is an essential component to constitute the network of the glass, and is a component to reduce cracking when the glass surface is flawed (indentation), or to reduce the destruction ratio when the glass is given indentation after chemical strengthening. In case where the content of SiO₂ is less than 56%, then the stability, the weather resistance as well as the chipping resistance of the glass would lower. The content of SiO₂ is preferably 58% or more, more preferably 60% or more. When the content of SiO₂ is more than 75%, then the viscosity of the glass would increase and the meltability thereof would lower.

Al₂O₃ is a component effective for improving the ion exchangeability and the chipping resistance of the glass, and is a component capable of increasing the surface compressive stress, and is a component capable of reducing the cracking incidence when given indentation by a 110° indenter. This is an essential component. When the Al₂O₃ content is less than 5%, then the desired surface compressive stress value and the desired compressive stress layer thickness could not be realized. Preferably, the content thereof is 9% or more. When the Al₂O₃ content is more than 20%, then the viscosity of the glass would increase and the glass would be difficult to melt homogeneously. The Al₂O₃ content is preferably 15% or less, and is typically 14% or less.

The total content of SiO₂ and Al₂O₃, SiO₂+Al₂O₃ is preferably 80% or less. When it is more than 80%, then the viscosity of the glass at high temperatures would increase and the glass of the type would be difficult to melt. Preferably, the total content thereof is 79% or less, more preferably 78% or less. Also preferably, SiO₂+Al₂O₃ is 70% or more. When it is less than 70%, then the cracking resistance of the glass when given indentation would lower. More preferably, the total content thereof is 72% or more.

Na₂O is a component of forming a surface compressive stress layer through ion exchange and improving the meltability of the glass, and is essential. When Na₂O content is less than 8%, then it would be difficult to form the desired surface compressive stress layer through ion exchange. Preferably, the content thereof is 10% or more, more preferably 11% or more. When Na₂O content is more than 22%, then the weather resistance of the glass would lower, and the glass would be readily cracked from the indentation given thereto. Preferably, the content thereof is 21% or less.

Though not essential, K₂O may be contained in the glass in an amount not more than 10% for increasing the ion exchange rate. When it is more than 10%, then the glass would be cracked from the indentation given thereto. If so, in addition, the surface compression stress change depending on the NaNO₃ concentration in the molten salt of potassium nitrate would increase. The K₂O content is 5% or less, preferably 0.8% or less, more preferably 0.5% or less, and typically 0.3% or less. For reducing the surface compressive stress change depending on the NaNO₃ concentration in the molten salt of potassium nitrate, it is desirable that the glass does not contain K₂O.

MgO is a component for increasing the surface compressive stress of the glass and for improving the meltability of the glass, and is essential. For suppressing stress relaxation, it is desirable to add MgO to the glass. In the case of not containing MgO, the glass of the type is disadvantage in that, in chemical strengthening treatment thereof, the degree of stress relaxation would vary in different sites of the chemical strengthening treatment chamber owing to the fluctuation in the temperature of the molten salt used, and as a result, it would be difficult to secure a stable compressive stress value. On the other hand, when MgO content is more than 14%, then the glass would be devitrified, and the surface compressive stress change depending on the NaNO₃ concentration in the molten salt of potassium nitrate would increase. Preferably, therefore, the content thereof is 13% or less.

The above-mentioned SiO₂—MgO is preferably 64% or less, more preferably 62% or less, and typically 61% or less.

The above-mentioned Al₂O₃—MgO is preferably 9% or less, more preferably 8% or less.

The total content of SiO₂, Al₂O₃, Na₂O and MgO is preferably 98% or more. When the total content thereof is less than 98%, then it is difficult to obtain the desired compressive stress layer while maintaining the cracking resistance thereof. Typically the total content thereof is 98.3% or more.

Though not essential, the glass may contain ZrO₂ in an amount of up to 5%, for reducing the viscosity thereof at high temperature and for increasing the surface compressive stress. When ZrO₂ content is more than 5%, then the glass may be cracked from the indentation given thereto. Consequently, the content thereof is preferably 2% or less, more preferably 1% or less, but typically the glass does not contain ZrO₂.

Though not essential, the glass may contain B₂O₃ in an amount not more than 6% for improving the meltability thereof at high temperature and for enhancing the glass strength. When B₂O₃ content is more than 6%, then a homogeneous glass is difficult to produce, and glass shaping would be difficult. In addition, if so, the cracking resistance of the glass would lower. Typically, the glass does not contain B₂O₃.

The total content of SiO₂, Al₂O₃, Na₂O and MgO is preferably 98% or more.

Regarding the preferred glass components, the glass sheet of the present invention essentially comprises the components mentioned above, but may contain any other component within a range not impairing the object of the present invention. When the glass sheet contains such optional components, the total content thereof is preferably less than 2%, more preferably 1% or less. Examples of the other components are described below.

The glass may optionally contain ZnO in an amount up to 2% for improving the meltability thereof at high temperature, but is preferably in an amount of 1% or less. In case where the glass is produced according to a float process, the content thereof is preferably 0.5% or less. When ZnO content is more than 0.5%, then it would be reduced during float shaping to cause product defects. Typically the glass does not contain ZnO.

TiO₂ may lower the visible light transmittance of the glass along with the Fe ion existing in the glass, and therefore may discolor the glass in brown. Consequently, even when the glass contains TiO₂, the content thereof is preferably 1% or less, but typically the glass does not contain TiO₂.

Li₂O is a component that may readily cause stress relaxation by lowering the strain point of the glass and, as a result, a stable surface compressive stress layer could not form in the glass. Consequently, preferably, the glass does not contain Li₂O. Even if the glass contains Li₂O, the content thereof is preferably less than 1%, more preferably 0.05% or less, even more preferably less than 0.01%.

Li₂O may dissolve out in the molten salt of KNO₃ or the like during chemical strengthening treatment, and chemical strengthening treatment with a molten salt containing Li would markedly lower the surface compressive stress of the glass. From this viewpoint, it is desirable that the glass does not contain Li₂O.

CaO may improve the meltability of the glass at high temperature or may make the glass hardly devitrify, and therefore, the glass may contain CaO in an amount of 5% or less. When CaO content is more than 5%, then the ion exchange rate would lower or the cracking resistance of the glass would also lower. Typically, the glass does not contain CaO.

The glass may optionally contain SrO, however, is more effective for lowering the ion exchange rate as compared with MgO and CaO. Consequently, even when the glass contains SrO, the content thereof is preferably less than 1%. Typically, the glass does not contain SrO.

BaO is, among alkaline earth metal oxides, most effective for lowering the ion exchange rate, and therefore, it is desirable that the glass does not contain BaO, but even when the glass contains it, the content thereof is preferably less than 1%.

When the glass contains SrO or BaO, the total content thereof is preferably 1% or less, more preferably less than 0.3%.

In case where the glass contains any one or more of CaO, SrO, BaO and ZrO₂, the total content of those four components is preferably less than 1.5%. When the total content thereof is 1.5% or more, then the ion exchange rate would lower. Typically, the total content thereof is 1% or less.

As a refining agent in melting the glass, the glass may optionally contain SO₃, chloride, fluoride, etc. However, for increasing the visibility of display devices such as touch panels, it is desirable that the components that may mix in the starting materials as impurities, such as Fe₂O₃, NiO, Cr₂O₃ and the like having an absorption in the visible light range, are reduced as much as possible, and preferably, the content of those impurities is, in terms of mass %, 0.15% or less, more preferably 0.05% or less, respectively.

### Examples

In Examples 1 to 45 in Tables 6 to 12, glass materials that are generally used in the art such as oxides, hydroxides, carbonates, nitrates and others were suitably selected so as to provide the compositions shown in the columns of from SiO₂ to K₂O, in terms of molar percentage expression (mass percentage expression), and were weighed so as to be 400 g as the resultant glass. To the thus-weighed sample, added was sodium nitrate in an amount of 0.2% by mass of the sample, and mixed. Next, the mixed material was put in a platinum crucible, set in a resistance heating electric furnace at 1650° C., melted therein for 6 hours, defoamed and homogenized. The resultant molten glass was cast into a mold, kept therein at a temperature of Tg+50° C. for 1 hour, and then cooled to room temperature at a rate of 0.5° C./min, to obtain a glass block.

In Tables 6 to 12, Examples 1 to 40 and 42 to 44 are working examples and Examples 41 and 45 are comparative examples.

Regarding these glasses, the Young's modulus E (unit: GPa), the glass transition point Tg (unit: ° C.), the temperature T2 (unit: ° C.) at which the viscosity thereof could be 10² dPa·s, the temperature T4 (unit: ° C.) at which the viscosity thereof could be 10⁴ dPa·s, and the average linear expansion coefficient α (unit: ⁻⁷/° C.) at 50 to 350° C. are shown in the Tables.

The glass block was cut and ground, and finally both surfaces thereof were mirror-finished to obtain a tabular glass having a size of 30 mm×30 mm and a thickness of 1.0 mm. The mirror-polishing step is as follows. The tabular glass was ground with a grinding stone #1000 by from 300 to 1000 μm to obtain a glass sheet, and then this was polished with a cerium oxide so that the surfaces thereof were mirror-finished.

Next, the tabular glass of Examples 1 to 45 was chemically strengthened in the manner mentioned below. The chemical strengthening condition was as follows. In Examples 1, 2, 11 to 14, 16, 18, 20 and 42, the glass was dipped in a molten salt containing 95% by mass of KNO₃ and 5% by mass of NaNO₃, at 425° C. for 6 hours for chemical strengthening treatment. In Examples 3, 4, 6, 15, 31 and 44, the glass was dipped in a molten salt containing 95% by mass of KNO₃ and 5% by mass of NaNO₃, at 425° C. for 10 hours for chemical strengthening treatment. In Examples 5, 7, 8, 10, 33 and 43, the glass was dipped in a molten salt containing 95% by mass of KNO₃ and 5% by mass of NaNO₃, at 450° C. for 6 hours for chemical strengthening treatment. In Examples 9 and 45, the glass was dipped in a molten salt containing 95% by mass of KNO₃ and 5% by mass of NaNO₃, at 450° C. for 10 hours for chemical strengthening treatment. In Examples 17, 19, 21, 24, 27, 30, 32, 34 to 38 and 40, the glass was dipped in a molten salt of 100% KNO₃ at 425° C. for 6 hours for chemical strengthening treatment. In Examples 22, 25, 28 and 41, the glass was dipped in a molten salt of 100% KNO₃ at 450° C. for 6 hours for chemical strengthening treatment. In Examples 23, 26, 29 and 39, the glass was dipped in a molten salt of 100% KNO₃ at 425° C. for 10 hours for chemical strengthening treatment.

After the chemical strengthening treatment, the glass was analyzed with a surface stress meter by Orihara Manufacturing's FSM-6000 to measure the surface compressive stress S thereof (unit: MPa) and the depth of the compressive stress layer thereof DOL (unit: μm), and the internal tensile stress T (unit: MPa) thereof was then calculated. The results are shown in the corresponding column in the Tables.

TABLE 6

| Example | 1 | | 2 | | 3 | | 4 | | 5 | | 6 | | 7 | |
|---|---|---|---|---|---|---|---|---|---|---|---|---|---|---|
| SiO₂ | 64 | (60.2) | 62 | (57.6) | 64 | (59.5) | 62 | (58.7) | 60 | (56.1) | 60 | (56.1) | 62 | (58.0) |
| Al₂O₃ | 12 | (19.2) | 14 | (22.1) | 14 | (22.1) | 12 | (19.3) | 14 | (22.2) | 14 | (22.2) | 14 | (22.2) |
| B₂O₃ | 0 | | 0 | | 0 | | 0 | | 0 | | 0 | | 0 | |
| MgO | 8 | (5.1) | 8 | (5.0) | 8 | (5.0) | 10 | (6.4) | 10 | (6.3) | 10 | (6.3) | 10 | (6.3) |
| CaO | 0 | | 0 | | 0 | | 0 | | 0 | | 0 | | 0 | |
| ZrO₂ | 0 | | 0 | | 0 | | 0 | | 0 | | 0 | | 0 | |
| Na₂O | 16 | (15.5) | 16 | (12.3) | 14 | (13.4) | 16 | (15.6) | 16 | (15.4) | 16 | (15.4) | 14 ( | 13.5) |

| | | | | | | | |
|---|---|---|---|---|---|---|---|
| K₂O | 0 | 0 | 0 | 0 | 0 | 0 | 0 |
| E | 77 | 79 | 80 | 79 | 81 | 81 | 82 |
| α | 2.47 | 2.48 | 2.46 | 2.48 | 2.49 | 2.49 | 2.47 |
| Tg | 659 | 689 | 724 | 661 | 691 | 691 | 726 |
| T2 | 1677 | 1711 | 1803 | 1631 | 1665 | 1665 | 1757 |
| T4 | 1272 | 1322 | 1400 | 1251 | 1301 | 1301 | 1379 |
| S | 881 | 874 | 850 | 859 | 917 | 866 | 877 |
| DOL | 30.0 | 27.9 | 33.3 | 31.2 | 33.7 | 30.5 | 32.5 |
| T | 28.1 | 25.8 | 30.3 | 28.6 | 33.1 | 28.1 | 30.5 |

TABLE 7

| Example | 8 | | 9 | | 10 | | 11 | | 12 | | 13 | | 14 | |
|---|---|---|---|---|---|---|---|---|---|---|---|---|---|---|
| SiO₂ | 60 | (57.2) | 58 | (54.6) | 60 | (56.5) | 60 | (56.4) | 58 | (53.8) | 60 | (55.7) | 66 | (62.6) |
| Al₂O₃ | 12 | (19.4) | 14 | (22.3) | 14 | (22.4) | 12 | (19.1) | 14 | (22.0) | 14 | (22.1) | 11 | (17.7) |
| B₂O₃ | 0 | | 0 | | 0 | | 0 | | 0 | | 0 | | 0 | |
| MgO | 12 | (7.7) | 12 | (7.6) | 12 | (7.6) | 8 | (5.0) | 8 | (5.0) | 8 | (5.0) | 8 | (5.1) |
| CaO | 0 | | 0 | | 0 | | 0 | | 0 | | 0 | | 0 | |
| ZrO₂ | 0 | | 0 | | 0 | | 0 | | 0 | | 0 | | 0 | |
| Na₂O | 16 | (15.7) | 16 | (15.5) | 14 | (13.6) | 20 | (19.4) | 20 | (19.1) | 18 | (17.2) | 15 | (14.7) |

| | | | | | | | |
|---|---|---|---|---|---|---|---|
| K₂O | 0 | 0 | 0 | 0 | 0 | 0 | 0 |
| E | 81 | 83 | 84 | 76 | 78 | 79 | 76 |
| α | 2.50 | 2.51 | 2.49 | 2.50 | 2.51 | 2.49 | 2.45 |
| Tg | 663 | 693 | 728 | 589 | 619 | 654 | 662 |
| T2 | 1585 | 1618 | 1711 | 1493 | 1527 | 1619 | 1707 |
| T4 | 1230 | 1280 | 1358 | 1116 | 1166 | 1244 | 1285 |
| S | 888 | 851 | 894 | 847 | 893 | 904 | 900 |
| DOL | 31.0 | 33.8 | 28.8 | 34.1 | 33.4 | 30.4 | 29.0 |
| T | 29.3 | 30.8 | 27.3 | 31.0 | 32.0 | 29.3 | 27.7 |

TABLE 8

| Example | 15 | | 16 | | 17 | | 18 | | 19 | | 20 | | 21 | |
|---|---|---|---|---|---|---|---|---|---|---|---|---|---|---|
| SiO₂ | 66 | (62.6) | 66 | (62.2) | 68 | (65.3) | 68 | (65.3) | 68 | (64.9) | 68 | (64.9) | 68 | (65.8) |
| Al₂O₃ | 11 | (17.7) | 12 | (19.2) | 9 | (14.7) | 9 | (14.7) | 10 | (16.2) | 10 | (16.2) | 9 | (14.8) |
| B₂O₃ | 0 | | 0 | | 0 | | 0 | | 0 | | 0 | | 0 | |
| MgO | 8 | (5.1) | 8 | (5.1) | 8 | (5.2) | 8 | (5.2) | 8 | (5.1) | 8 | (5.1) | 10 | (6.5) |
| CaO | 0 | | 0 | | 0 | | 0 | | 0 | | 0 | | 0 | |
| ZrO2 | 0 | | 0 | | 0 | | 0 | | 0 | | 0 | | 0 | |
| Na₂O | 15 | (14.7) | 14 | (13.6) | 15 | (14.9) | 15 | (14.9) | 14 | (13.8) | 14 | (13.8) | 13 | (13.0) |

| | | | | | | | |
|---|---|---|---|---|---|---|---|
| K₂O | 0 | 0 | 0 | 0 | 0 | 0 | 0 |
| E | 76 | 77 | 73 | 73 | 75 | 75 | 76 |
| α | 2.45 | 2.45 | 2.44 | 2.44 | 2.44 | 2.44 | 2.44 |
| Tg | 662 | 694 | 632 | 632 | 665 | 665 | 669 |
| T2 | 1707 | 1770 | 1674 | 1674 | 1736 | 1736 | 1719 |
| T4 | 1285 | 1349 | 1234 | 1234 | 1299 | 1299 | 1291 |
| S | 896 | 888 | 1120 | 850 | 1200 | 859 | 1152 |
| DOL | 35.0 | 29.0 | 34.0 | 30.0 | 31.0 | 29.0 | 26.0 |
| T | 33.7 | 27.3 | 40.9 | 27.1 | 39.7 | 26.4 | 31.6 |

TABLE 9

| Example | 22 | | 23 | | 24 | | 25 | | 26 | | 27 | | 28 | |
|---|---|---|---|---|---|---|---|---|---|---|---|---|---|---|
| SiO₂ | 68 | (65.8) | 68 | (65.8) | 68 | (65.3) | 68 | (65.3) | 68 | (65.3) | 68 | (64.9) | 68 | (64.9) |
| Al₂O₃ | 9 | (14.8) | 9 | (14.8) | 10 | (16.3) | 10 | (16.3) | 10 | (16.3) | 11 | (17.8) | 11 | (17.8) |
| B₂O₃ | 0 | | 0 | | 0 | | 0 | | 0 | | 0 | | 0 | |
| MgO | 10 | (6.5) | 10 | (6.5) | 10 | (6.4) | 10 | (6.4) | 10 | (6.4) | 10 | (6.4) | 10 | (6.4) |
| CaO | 0 | | 0 | | 0 | | 0 | | 0 | | 0 | | 0 | |
| ZrO₂ | 0 | | 0 | | 0 | | 0 | | 0 | | 0 | | 0 | |
| Na₂O | 13 | (13.0) | 13 | (13.0) | 12 | (11.9) | 12 | (11.9) | 12 | (11.9) | 11 | (10.8) | 11 | (10.8) |

| | | | | | | | |
|---|---|---|---|---|---|---|---|
| K₂O | 0 | 0 | 0 | 0 | 0 | 0 | 0 |
| E | 76 | 76 | 77 | 77 | 77 | 79 | 79 |
| α | 2.44 | 2.44 | 2.43 | 2.43 | 2.43 | 2.43 | 2.43 |
| Tg | 669 | 669 | 702 | 702 | 702 | 734 | 734 |
| T2 | 1719 | 1719 | 1782 | 1782 | 1782 | 1845 | 1845 |
| T4 | 1291 | 1291 | 1356 | 1356 | 1356 | 1420 | 1420 |
| S | 1107 | 1143 | 1137 | 1116 | 1131 | 1074 | 1060 |
| DOL | 35.0 | 34.0 | 26.0 | 35.0 | 33.0 | 25.0 | 33.0 |
| T | 41.7 | 41.7 | 31.2 | 42.0 | 40.0 | 28.3 | 37.5 |

TABLE 10

| Example | 29 | | 30 | | 31 | | 32 | | 33 | | 34 | | 35 | |
|---|---|---|---|---|---|---|---|---|---|---|---|---|---|---|
| SiO₂ | 68 | (64.9) | 68 | (64.6) | 68 | (64.6) | 68 | (64.3) | 68 | (64.3) | 68 | (64.0) | 68 | (64.6) |
| Al₂O₃ | 11 | (17.8) | 10 | (16.1) | 10 | (16.1) | 10 | (16.0) | 10 | (16.0) | 10 | (16.0) | 10 | (16.1) |
| B₂O₃ | 0 | | 0 | | 0 | | 0 | | 0 | | 0 | | 0 | |
| MgO | 10 | (6.4) | 8 | (5.1) | 8 | (5.1) | 8 | (5.1) | 8 | (5.1) | 8 | (5.0) | 8 | (5.1) |
| CaO | 0 | | 0 | | 0 | | 0 | | 0 | | 0 | | 0 | |
| ZrO₂ | 0 | | 0.5 | (1.0) | 0.5 | (1.0) | 1 | (1.9) | 1 | (1.9) | 1.5 | (2.9) | 0 | |
| Na₂O | 11 | (10.8) | 13.5 | (13.2) | 13.5 | (13.2) | 13 | (12.7) | 13 | (12.7) | 12.5 | (12.1) | 13 | (12.7) |

| | | | | | | | | |
|---|---|---|---|---|---|---|---|---|
| K₂O | 0 | 0 | 0 | 0 | 0 | 0 | 1 | (1.5) |

| | | | | | | | |
|---|---|---|---|---|---|---|---|
| E | 79 | 75 | 75 | 76 | 76 | 76 | 76 |
| α | 2.43 | 2.45 | 2.45 | 2.46 | 2.46 | 2.47 | 2.43 |
| Tg | 734 | 673 | 673 | 682 | 682 | 690 | 677 |
| T2 | 1845 | 1759 | 1759 | 1782 | 1782 | 1805 | 1782 |
| T4 | 1420 | 1318 | 1318 | 1338 | 1338 | 1357 | 1338 |
| S | 1069 | 1165 | 887 | 1164 | 856 | 1160 | 1154 |
| DOL | 33.0 | 30.0 | 34.0 | 28.0 | 34.0 | 26.0 | 31.0 |
| T | 37.8 | 37.2 | 32.4 | 34.5 | 31.2 | 31.8 | 38.1 |

TABLE 11

| Example | 36 | | 37 | | 38 | | 39 | | 40 | | 41 | | 42 | |
|---|---|---|---|---|---|---|---|---|---|---|---|---|---|---|
| SiO₂ | 68 | (64.2) | 68 | (64.3) | 68 | (64.0) | 68 | (64.0) | 66 | (61.8) | 66 | (61.8) | 68 | (64.5) |
| Al₂O₃ | 10 | (16.0) | 10 | (16.0) | 10 | (16.0) | 10 | (16.0) | 13 | (20.6) | 13 | (20.6) | 11 | (17.7) |
| B₂O₃ | 0 | | 0 | | 0 | | 0 | | 0 | | 0 | | 0 | |
| MgO | 8 | (5.1) | 8 | (5.1) | 8 | (5.0) | 8 | (5.0) | 8 | (5.0) | 8 | (5.0) | 8 | (5.1) |
| CaO | 0 | | 0 | | 0 | | 0 | | 0 | | 0 | | 0 | |
| ZrO₂ | 0 | | 0.5 | (1.0) | 1 | (1.9) | 1 | (1.9) | 0 | | 0 | | 0 | |
| Na₂O | 12 | (11.7) | 12.5 | (12.2) | 12 | (11.6) | 12 | (11.6) | 13 | (12.6) | 13 | (12.6) | 13 | (12.7) |

| | | | | | | | | | | | |
|---|---|---|---|---|---|---|---|---|---|---|---|
| K₂O | 2 | (3.0) | 1 | (1.5) | 1 | (1.5) | 1 | (1.5) | 0 | 0 | 0 |

| | | | | | | | |
|---|---|---|---|---|---|---|---|
| E | 77 | 76 | 77 | 77 | 79 | 79 | 76 |
| α | 2.43 | 2.44 | 2.46 | 2.46 | 2.44 | 2.44 | 2.43 |
| Tg | 689 | 685 | 694 | 694 | 727 | 727 | 697 |
| T2 | 1828 | 1805 | 1828 | 1828 | 1832 | 1832 | 1799 |
| T4 | 1377 | 1357 | 1377 | 1377 | 1414 | 1414 | 1363 |
| S | 1070 | 1123 | 1110 | 1103 | 1300 | 1243 | 843 |
| DOL | 31.0 | 30.0 | 28.0 | 35.0 | 29.0 | 40.0 | 28.0 |
| T | 35.4 | 35.8 | 32.9 | 41.5 | 40.0 | 54.0 | 25.0 |

TABLE 12

| Example | 43 | 44 | 45 |
|---|---|---|---|
| SiO₂ | 68(64.5) | 68(64.5) | 68(64.5) |
| Al₂O₃ | 11(17.7) | 11(17.7) | 11(17.7) |
| B₂O₃ | 0 | 0 | 0 |
| MgO | 8(5.1) | 8(5.1) | 8(5.1) |
| CaO | 0 | 0 | 0 |
| ZrO₂ | 0 | 0 | 0 |
| Na₂O | 13(12.7) | 13(12.7) | 13(12.7) |
| K₂O | 0 | 0 | 0 |
| E | 76 | 76 | 76 |
| α | 2.43 | 2.43 | 2.43 |
| Tg | 697 | 697 | 697 |
| T2 | 1799 | 1799 | 1799 |
| T4 | 1363 | 1363 | 1363 |
| S | 843 | 836 | 845 |
| DOL | 38.0 | 36.0 | 50.0 |
| T | 34.7 | 32.4 | 46.9 |

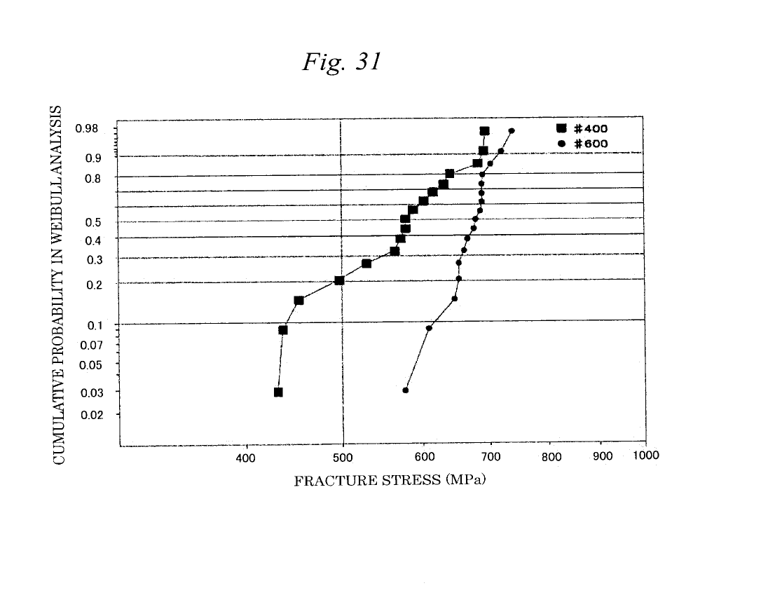

FIG. 31 shows Weibull plots of indicating the four-point bending strength of chemically strengthened glass sheets of one embodiment of the present invention. For the samples of the chemically strengthened glass sheet tested herein, those having the same composition as in Examples 19 and 20 were strengthened. The surface compressive stress S of the samples was 905 MPa, DOL thereof was 22.7 μm and the thickness thereof was 1.1 mm. After the chemical strengthening, the samples were chamfered with grinding stones having a different particle size. Used here, the abrasive grains in the grinding stone #400 had an average particle diameter of from 44 to 37 μm (maximum particle diameter 75 μm), and those in the grinding stone #600 had an average particle diameter of from 26 to 31 μm (maximum particle diameter 53 μm).

As described above, for preventing all the four damage modes, the value of surface compressive stress S is preferably higher, but on the other hand, the value of internal tensile stress T is preferably lower. In the chemically strengthened glass of this embodiment, the sheet edge surfaces were polished to further increase the bending strength of the glass while the value of surface compressive stress S and the value of internal tensile stress T of the glass were kept controlled to be on a suitable level.

As seen from FIG. 31, some samples of the chemically strengthened glass sheet that had been polished with the grinding stone #400 had a bending strength of 500 MPa or less, but all the samples of the chemically strengthened glass sheet that had been polished with the grinding stone #600 did not have such a low bending strength of 500 MPa or less. In general, chemically strengthened glass sheets are required to have a practicable bending strength of 500 MPa or more, and therefore by polishing with the grinding stone #600, the chemically strengthened glass sheets can secure the bending strength of 500 MPa or more while the internal tensile stress T thereof is kept to be lower than a prescribed level. In addition, from the viewpoint of the outward appearance thereof, it is desirable that the chemically strengthened glass sheet is polished with a grinding stone having a particle size of #600 or more.

The depth of the latent flaw (pit) in the chamfered part of each glass sheet was measured. The maximum depth of the chemically strengthened glass sheet that had been polished with the grinding stone #400 was 25 μm, and that of the chemically strengthened glass sheet that had been polished with the grinding stone #600 was 20 μm. Consequently, in particular, when the depth of the latent flaw (pit) in the chamfered part, especially in the part where the distance from the main surface adjacent to the chamfered part toward the sheet thickness direction is ⅕ or less of the sheet thickness, is controlled to be 20 μm or less, then there can be provided a chemically strengthened glass sheet resistant to various damage modes. From FIG. 31, it can be seen that the probability that the chemically strengthened glass sheet polished with the grinding stone #400, in which the maximum depth of the latent flaw (pit) formed is 25 μm, is broken at a bending strength of 500 MPa or less is approximately 20% or so. On the other hand, the probability of breaking at a bending strength of 500 MPa or less can be extremely lowered when the maximum depth of the latent flaw (pit) is 20 pin. The latent flaw depth is measured by repeating the etching treatment, as described above. The surface roughness Ra of the chemically strengthened glass sheet, polished with the grinding stone #400, was 0.43 μm, and the surface roughness Ra of the chemically strengthened glass sheet, polished with the grinding stone #600, was 0.26 μm.

As shown in the above, there can be provided a chemically strengthened glass sheet resistant to various types of damage modes, by polishing the edge surfaces of the sheet with controlling the values of the surface compressive stress S and the internal tensile stress T thereof to be on a prescribed level.

### INDUSTRIAL APPLICABILITY

The present invention is applicable to cover glass of display devices and to touch sensor-attached chemically strengthened glass, etc. In addition, the invention is also applicable to solar cell substrates, windowpanes for airplanes, etc.

The present application is based on Japanese Patent Application No. 2012-119719 filed on May 25, 2012, Japanese Patent Application No. 2012-123353 filed on May 30, 2012, and Japanese Patent Application No. 2012-233702 filed on Oct. 23, 2012, and the contents of which are incorporated herein by reference.

### DESCRIPTION OF REFERENCE NUMERALS AND SIGNS

10 GLASS SHEET
11, 12 MAIN SURFACE
13 EDGE SURFACE
13a, 13b PRESCRIBED PART OF EDGE SURFACE
15, 16 CHAMFERED PART
17 ETCHED SURFACE
18 PIT
21, 22 CHEMICALLY STRENGTHENED LAYER (COMPRESSIVE STRESS LAYER)
23 INTERNAL TENSILE STRESS LAYER
110 GLASS SHEET
120 SPACER
130 LAMINATE
140 BRUSH
142 BRISTLE
210 TOUCH SENSOR-ATTACHED CHEMICALLY STRENGTHENED GLASS
211 TOUCH SENSOR
220 CHEMICALLY STRENGTHENED GLASS
240 ROTARY GRINDING STONE
340 SHEET

1. A chemically strengthened glass sheet, which has front and back main surfaces and an edge surface between the front and back main surfaces,
wherein the chemically strengthened glass sheet has a surface compressive stress of 800 MPa or more, and an internal tensile stress of 42 MPa or less,
the edge surface has a chamfered part, and a part of the chamfered part where a distance from the main surface adjacent to the chamfered part toward a sheet thickness direction is ⅕ or less of a sheet thickness has no latent flaw deeper than 20 μm, and
the chemically strengthened glass sheet contains, in terms of mol % on the basis of oxides, from 56 to 75% of SiO₂, from 5 to 20% of Al₂O₃, from 8 to 22% of Na₂O, from 0 to 10% of K₂O, from 0 to 14% of MgO, from 0 to 5% of ZrO₂ and from 0 to 5% of CaO.

2. The chemically strengthened glass sheet according to claim 1, which has the surface compressive stress of 850 MPa or more.

3. The chemically strengthened glass sheet according to claim 1, which has the internal tensile stress of 35 MPa or less.

4. The chemically strengthened glass sheet according to claim 3, which has the internal tensile stress of 30 MPa or less.

5. The chemically strengthened glass sheet according to claim 1, which has a thickness of a surface compressive stress layer of from 15 to 40 μm.

6. The chemically strengthened glass sheet according to claim 5, which has the thickness of the surface compressive stress layer of from 20 to 35 μm.

7. The chemically strengthened glass sheet according to claim 1, which has a sheet thickness of 0.8 mm or less.

8. The chemically strengthened glass sheet according to claim 1, wherein a total content of SiO₂, Al₂O₃, Na₂O, MgO and B₂O₃ is 98% or more.

9. The chemically strengthened glass sheet according to claim 1, wherein a total content of SiO₂, Al₂O₃, Na₂O and MgO is 98% or more.

10. The chemically strengthened glass sheet according to claim 1, wherein a difference resulting from subtracting an Al₂O₃ content from a Na₂O content is less than 5%.

11. The chemically strengthened glass sheet according to claim 1, wherein the part of the chamfered part where the distance from the main surface adjacent to the chamfered part toward the sheet thickness direction is ⅕ or less of the sheet thickness has no latent flaw of 10 μm or deeper.

12. The chemically strengthened glass sheet according to claim 1, wherein a touch sensor is provided on the main surface.

13. A chemically strengthened glass sheet, which has front and back main surfaces and an edge surface between the front and back main surfaces,
wherein the chemically strengthened glass sheet has a surface compressive stress of 800 MPa or more, and an internal tensile stress of 42 MPa or less,
the edge surface has a chamfered part, and a part of the chamfered part where a distance from the main surface adjacent to the chamfered part toward a sheet thickness direction is ⅕ or less of a sheet thickness has no latent flaw deeper than 20 μm, and
the chemically strengthened glass sheet contains, in terms of mol % on the basis of oxides, from 60 to 75% of SiO₂, from 11 to 15% of Al₂O₃, from 11 to 16% of Na₂O, from 0 to 5% of K₂O, from 0 to 10% of MgO, from 0 to 1% of ZrO₂ and from 0 to 5% of CaO.

14. The chemically strengthened glass sheet according to claim 13, which has the surface compressive stress of 850 MPa or more.

15. The chemically strengthened glass sheet according to claim 13, which has the internal tensile stress of 35 MPa or less.

16. The chemically strengthened glass sheet according to claim 15, which has the internal tensile stress of 30 MPa or less.

17. The chemically strengthened glass sheet according to claim 13, which has a thickness of a surface compressive stress layer of from 15 to 40 μm.

18. The chemically strengthened glass sheet according to claim 17, which has the thickness of the surface compressive stress layer of from 20 to 35 μm.

19. The chemically strengthened glass sheet according to claim 13, which has a sheet thickness of 0.8 mm or less.

20. The chemically strengthened glass sheet according to claim 13, wherein a total content of SiO₂, Al₂O₃, Na₂O, MgO and B₂O₃ is 98% or more.
